(19) United States
(12) Patent Application Publication
(10) Pub. No.: US 2010/0199631 A1
(43) Pub. Date: Aug. 12, 2010

(54) POWER PRODUCTION PROCESS WITH GAS TURBINE FROM SOLID FUEL AND WASTE HEAT AND THE EQUIPMENT FOR THE PERFORMING OF THIS PROCESS

(75) Inventors: Ladislav VILIMEC, Ostrava (CZ); Kamil STAREK, Ostrava (CZ)

Correspondence Address: BIRCH STEWART KOLASCH & BIRCH, PO BOX 747, FALLS CHURCH, VA, 22040-0747, US

(73) Assignee: VITKOVICE POWER ENGINEERING a.s., Ostrava (CZ)

(21) Appl. No.: 12/607,800

(22) Filed: Oct. 28, 2009

(30) Foreign Application Priority Data
Oct. 29, 2008 (EP) 08466028.1

(51) Int. Cl. F02C 6/00; F01K 25/02; F28D 15/00

(52) U.S. Cl. 60/39.182; 60/650; 165/104.19

(57) ABSTRACT

The power production process with a gas turbine where as primary power source solid fossil fuels, alternative fuels and wastes at their combustion with air or oxygen can be utilized. The operating medium is the steam-gas mixture of gas supplied by a compressor (22) and of steam of the cooling medium of the cooled combustion chamber (1), whereas the injected medium is injected into the gas forwarded by means of the compressor (22) before the compressor (22) or before the heater (7) of the steam-gas mixture or at least between some parts of the heater (7). The gas turbine (28) can be utilized in connection with a regeneration exchanger or with the installation of the Rankine-Clausius steam cycle utilizing the waste heat of flue gas from the gas turbine (28). The gas turbine (28) operates with the so-called humid cycle, which enables to utilize the heat of the cooling medium of the combustion chamber (1) as well as the isothermal compression at the compression of the gas creating the operating medium of the gas turbine (28). The operating medium is together with this gas also the steam of the cooling medium of the combustion chamber (1). The temperature of the steam-gas mixture before as well as after the gas turbine (28) can be increased by reheating and the temperature of the steam-gas mixture after the gas turbine (28) can be increased by reheating by the flue gas of the combusted primary fuel.

### AREA OF TECHNOLOGY

The invention is related to a process of electric power production, eventually to the co-generation of heat and power, based on the utilization of primary energy of fossil fuels as well as of primary energy of alternative fuels and wastes, by their combustion, eventually on the utilization of the heat of waste gas, namely with application of gas turbine with an indirect heating and a humid cycle (HAT), eventually combined cycle with such a gas turbine and steam cycle and it deals with the processes of the creation of a steam-gas mixture as an operating medium for the gas turbine, its heating to the operating temperature and by its cooling down with reaching maximum possible amount of steam of this steam-gas mixture.

### PRESENT STATE OF TECHNOLOGY

Presently, the major part of electric power is produced in steam turbine power plants, where the Rankine-Clausius steam cycle for the conversion of the thermal power of the operating medium (steam) to mechanical power is used—the presently reached efficiencies at the conversion of the primary energy (e.g. coal at its combustion) to electric power are at supercritical steam parameters c. 45%.

In term of the reached total efficiency of the conversion of the primary power of the fuels to electric power today the most successful cycles are the combined steam-gas cycles (GTCC) including the turbines with humid cycle (HAT), the efficiency of which is higher than 50% and nowadays the value of 60% is reachable. However, quality gaseous and liquid fuels are used as fuel.

For the utilization of the primary power of solid fossil fuels, alternative fuels and wastes for power production or for the co-generation of heat and power, mainly the Rankine-Clausius cycle, eventually the Organic Rankine-Clausius cycle (ORC) are used for the combustion of biomass. The reached efficiencies of the power conversion at the electric power production are significantly lower than at the utilization of the combined steam-gas cycle.

For the utilization of the primary energy of solid fuels (especially of coal) by the means of the Brayton cycle, nowadays e.g. the system IGCC (Integrated Gasification Combined Cycle) is developed, which is a cycle based on the gasification of solid fuels and wastes with subsequent combustion of the acquired gas in a gas turbine or a combined cycle based on coal combustion in a HITAF (High Temperature Air Furnace).

Gas turbines with an indirect heating of the operating medium are also utilized, heated for example by flue gas from the biomass and waste combustion, also systems where directly the flue gas originated from the combustion of solid fuels serves as the operating medium are developed.

The necessary purity of gas or flue gas entering the gas turbine must be ensured with all systems using the Brayton cycle.
Systems with the combustion of fuels with oxygen are also developed, the aim is to enable the separation of the CO₂ originated from the combustion and its possible subsequent utilization, or the more probable possibility of its deposition with the elimination of negative influence on the environment.

### PRINCIPLE OF THE INVENTION

The advantage of the design of the invention is following: Solid fossil fuels for the production of electric power or for the co-generation of power and heat, alternative fuels and wastes for their combustion with air or oxygen in well-proven, commonly used kinds of combustion equipment, e.g. with a stoker fired, pulverized fuel, gas, or oil furnace or fluidized bed can be used as the source of primary power.

The combustion equipment is of common design. The combustion chamber is connected as an evaporator at conventional boilers and the produced steam after mixing up with gas generated by compressor of a gas turbine creates a steam-gas mixture, which after further heating by flue gas after the combustion chamber is used as the operating medium of the gas turbine. The heat acquired by the cooling of the combustion chamber is hereby utilized for reaching the necessary heat input of the operating medium of the gas turbine.

As a source of primary energy, instead of fuel also the waste heat of various equipment can be used, e.g. of flue gas, of steam, of water.

Of advantage is also the fact that for the flue gas treatment commonly accessible technologies can be used.

Of advantage is also the fact that the gas turbine can be used in connection to a regeneration exchanger as well as to an installation of the Rankine-Clausius steam cycle using the waste gas heat (flue gas heat) from the gas turbine.

Of advantage is also the fact that the gas turbine operates with the so-called humid cycle, which enables to utilize the heat of the cooling medium of the combustion chamber and also easily carry out a partial isothermal compression at pressing of the gas, which is a component of the operating medium of the gas turbine.

Of advantage is also the fact that the temperature of the steam-gas mixture before and after the gas turbine can be increased by additional heating e.g. by natural gas, by which means the steam content in the steam-gas mixture increases, and that the temperature of the steam-gas mixture after the gas turbine can be increased by reheating by the flue gas of the combusted primary fuel.

Of advantage is also the fact that the steam amount in the steam-gas mixture at the intake of the gas turbine can be controlled according to the needs of the heat circuit by extraction of the unusable steam produced by cooling of the combustion chamber along with securing of a sufficient cooling of the combustion chamber.

Of advantage is also the fact that the heat-exchanging surfaces of the equipment with a high temperature of the operating medium are exposed to a low pressure.

Of advantage is also the fact that by a suitable connection a maximum of condensate from the steam-gas mixture after the gas turbine can be acquired back and this way the necessary amount of the additional cooling medium can be reduced.

Of advantage is also the fact that the system can be operated as a source of electric power only or as a co-generation source of heat and power.

Of advantage is also the fact that the steam for the steam-gas mixture can be acquired by evaporation of the liquid in this mixture.

### BRIEF DESCRIPTION OF THE DRAWINGS

FIG. 1 shows the connection with a cooled combustion chamber for the combustion of fossil as well as alternative fuels and wastes with the application of Brayton humid cycle and Rankine-Clausius steam cycle;

FIG. 2 shows the connection for the utilization of the Brayton humid cycle for the utilization of the sensible heat of the flue gas or mixtures of gases of various aggregates;

FIG. 3 shows the connection with the cooled combustion chamber with the application of the Brayton humid cycle and the Rankine-Clausius cycle;

FIG. 4 shows the connection with a cooled combustion chamber or a heat aggregate at only the application of the Brayton cycle with the return of the condensate from the steam-gas mixture is presented;

FIG. 5 shows the connection with the Brayton humid cycle for the utilization of the sensible heat of flue gas with preheating of the injected water and the return of the condensate is presented;

FIG. 6 shows the connection with the preheating of an additional cooling medium is presented;

FIG. 7 shows the connection with the preheating of air before the compressor is presented;

FIG. 8 is an alternative connection of the injected medium is presented;

FIG. 9 shows the connection for an isothermal compression is presented;

FIG. 10 shows the connection for increasing of the temperature of the steam-gas mixture after the turbine by heating by flue gas or waste gas is presented;

FIG. 11 shows the connection for increasing of the temperature of the steam-gas mixture after the gas turbine by additional burning of e.g. natural gas;

FIG. 12 represents the connection with preheating of the cooling medium by flue gas;

FIG. 13 shows the connection with preheating of the injected medium at connection with the installation of the Rankine-Clausius steam cycle is presented;

FIG. 14 shows the connection with a superheater of the steam in the flue gas after the cooled combustion chamber is presented;

FIG. 15 shows the connection with a superposed high-pressure steam turbine is presented;

FIG. 16 the connection with a steam superheater without an additional turbine is presented;

FIG. 17 shows the connection with an additional condensing turbine is presented;

FIG. 18 shows the connection with a steam superheater with a back-pressure turbine is presented;

FIG. 19 shows the connection with a steam superheater with a condensing turbine with controlled extraction is presented;

FIG. 20 shows the connection with a steam superheater with a back-pressure turbine with controlled extraction is presented;

FIG. 21 shows the connection with divided steam superheater in a cooled combustion chamber is presented;

FIG. 22 shows the connection with a steam superheater is presented;

FIG. 23 shows the connection with the inlet part of the superheater for the steam-gas mixture in a cooled combustion chamber is presented;

FIG. 24 shows the connection with the output part of the heater for the steam-gas mixture in a cooled combustion chamber is presented; and

FIG. 25 shows the connection with the inner part of the heater for the steam-gas mixture in a cooled combustion chamber is presented.

### EXAMPLES OF DESIGN OF THE INVENTION

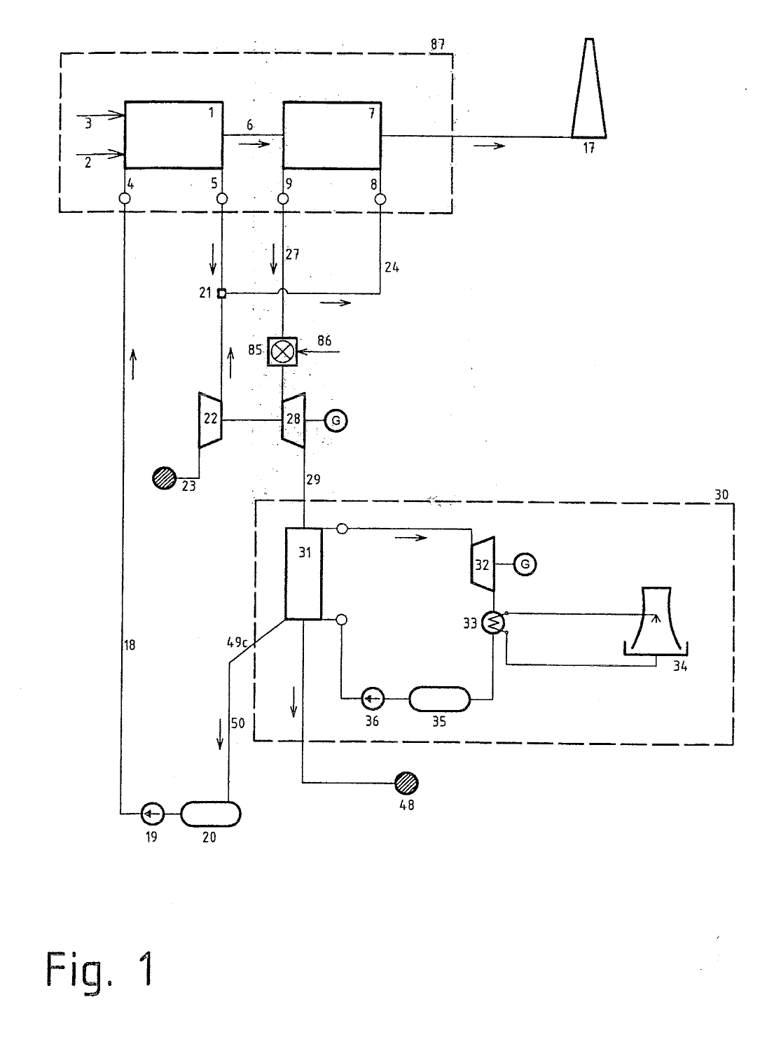

The power cycle according to the exemplary design in FIG. 1 consists of a cooled combustion chamber 1 with fuel supply 2 and combustion air supply 3, further with cooling medium 4 supply and output 5 of the steam of the cooling medium, which is connected by means of a hot flue gas duct 6 to the heater 7 for the steam-gas mixture with steam-gas mixture supply 8 and outlet 9 of steam-gas mixture, which is connected to stack 17. The cooled combustion chamber 1 and the heater 7 for the steam-gas mixture are in this case installations of the steam-gas generator 87. The cooled combustion chamber 1 can be in this exemplary design with a stoker fired, pulverized fuel, or fluidized-bed furnace for the combustion of various types of coal, alternative fuels as well as wastes, or with any other suitable furnace. The cooling medium supply 4 is connected to the pipe 18 of the cooling medium with feed pump 19, which is connected to the cooling medium tank 20. The output 5 of the steam of the cooling medium is connected to the mixing piece 21, which is connected to the output from the compressor 22 with air suction pipe 23. The mixing piece 21 is further connected to the steam-gas mixture supply 8 by means of connecting pipe 24. The outlet 9 of the steam-gas mixture is the supply pipe 27, in which a gas burner 85 can be located, connected to a gas turbine 28 with a generator, output of which is by means of the output pipe 29 of the steam-gas mixture connected to the installation 30 of the Rankine-Clausius cycle, which consist of the steam generator 31 for waste heat with the condensate drain pipe 49c, which is connected to the condensate collecting pipe 50, further of the steam turbine 32 with a generator, condenser 33, cooling tower 34, condensate tank 35 and condensation feed pump 36. The output of the steam-gas mixture from the installation 30 of the Rankine-Clausius cycle is connected to the exhaust pipe 48 of the operating medium.

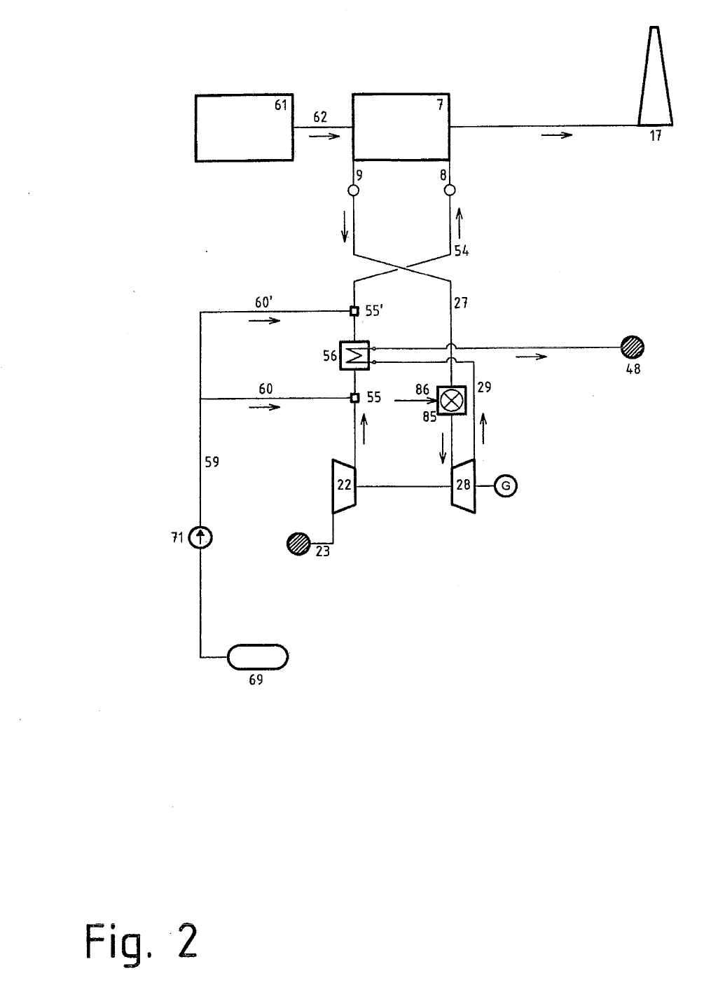

The power cycle according to the alternative design in FIG. 2 consists of an aggregate 61 producing waste gas or a mixture of gases of necessary temperature, e.g. from a heating furnace, a high-temperature fuel cell, which is connected to the heater 7 for the steam-gas mixture and further to stack 17 by means of a gas duct 62. The steam-gas mixture supply 8 is by means of steam-gas pipe 54, where the mixing cooler 55′, the regenerative heat-exchanger 56, which is an exchanger re-utilizing the waste heat, and the mixing cooler 55 are included, connected to the output of the compressor 22 with air suction pipe 23. The outlet 9 of the steam-gas mixture is by means of supply pipe 27, where a gas burner 85 can be located, connected to the input of the gas turbine 28, the output of which is by means of the steam-gas mixture output pipe 29 connected to the regenerative heat exchanger 56, the output of which is connected to operating medium exhaust pipe 48. The mixing coolers 55 and 55′ are by means of injection pipes 60 and 60′ connected to pressure pipe 59 with injection pump 71, which is connected to the reservoir 69 of the injected medium.

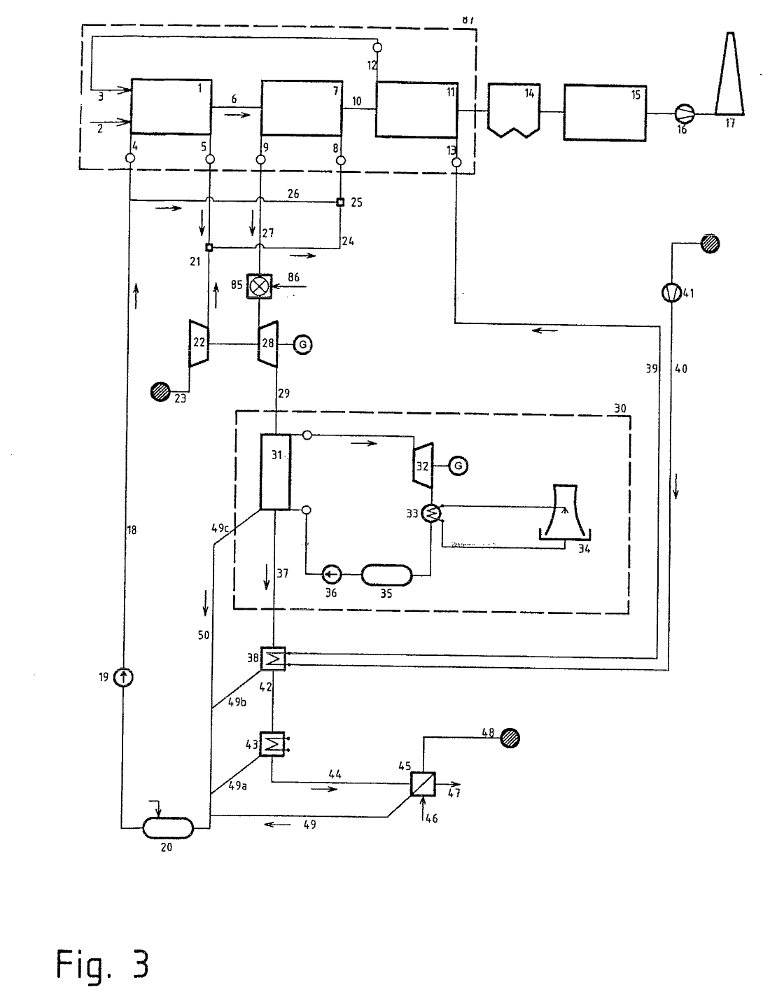

In the alternative design in FIG. 3 the power cycle consists of a cooled combustion chamber 1 with fuel supply 2 and combustion air supply 3, further with cooling medium supply 4 and output 5 of the steam of the cooling medium, which is connected by means of a hot flue gas duct 6 to the heater 7 of the steam-gas mixture with supply 8 of the steam-gas mixture and the outlet 9 of the steam-gas mixture, which is by means of a flue gas duct 10 connected to the combustion air heater 11 with the hot air output 12 and the input of preheated air 13. The cooled combustion chamber 1, the heater 7 of the steam-gas mixture and the heater of the combustion air 11 are in this case installations of the steam-gas generator 87. After the heater 11 of the combustion air a separator 14 of solid pollutants, a device 15 for the cleaning of flue gas, a flue-gas fan 16 and a stack 17 are further connected. The cooling medium supply is connected to the pipe 18 of the cooling medium with a feed pump 19, which is connected to the cooling medium tank 20. The output 5 of the steam of the cooling medium is connected to the mixing piece 21, which is connected to the output of the compressor 22 with suction pipe 23. The mixing piece 21 is by means of connecting pipe 24, in which there is an injection cooler 25, which is connected by means of the injected medium pipe 26 to the cooling medium pipe 18, further connected to the steam-gas mixture supply 8. The outlet 9 of the steam-gas mixture is by means of supply pipe 27, in which a gas burner 85 can be placed, connected to the gas turbine 28 with a generator, the output of which is the output pipe 29 of the steam-gas mixture connected to the installation 30 of the Rankine-Clausius steam cycle. The output of the steam-gas mixture from the installation 30 of the Rankine-Clausius steam cycle is by means of supply pipe 37 connected to the combustion air preheater 38, which is on the side of the cooling medium by means of the heated air output duct 39 connected to combustion air heater 11 and by means of the cool air input duct 40 connected to the combustion air fan 41. The output of the steam-gas mixture from the combustion air preheater 38 is connected to the warm service water heater 43 by means of the drain pipe 42. The warm service water heater 43 is on the output side of the steam-gas mixture by means of the outlet pipe 44 connected to the separation condenser 45 with input 46 and output 47 of the cooling medium. This is on the side of the output of the operating medium connected to operating medium exhaust pipe 48 and on the condensate output side it is connected to the condensate pipe 49, which is fed into condensate collecting pipe 50, into which the pipes 49a, 49b, and 49c of the condensate from the warm service water heater 43, combustion air preheater 38 and steam generator 31 are fed and which is connected to the cooling medium tank 20. At the alternative connection the sequence of the connection of the combustion air preheater 38 and of the warm service water heater 43 can be inverted or the separation condenser 43 can be left out, eventually a combination of the named possibilities can be applied.

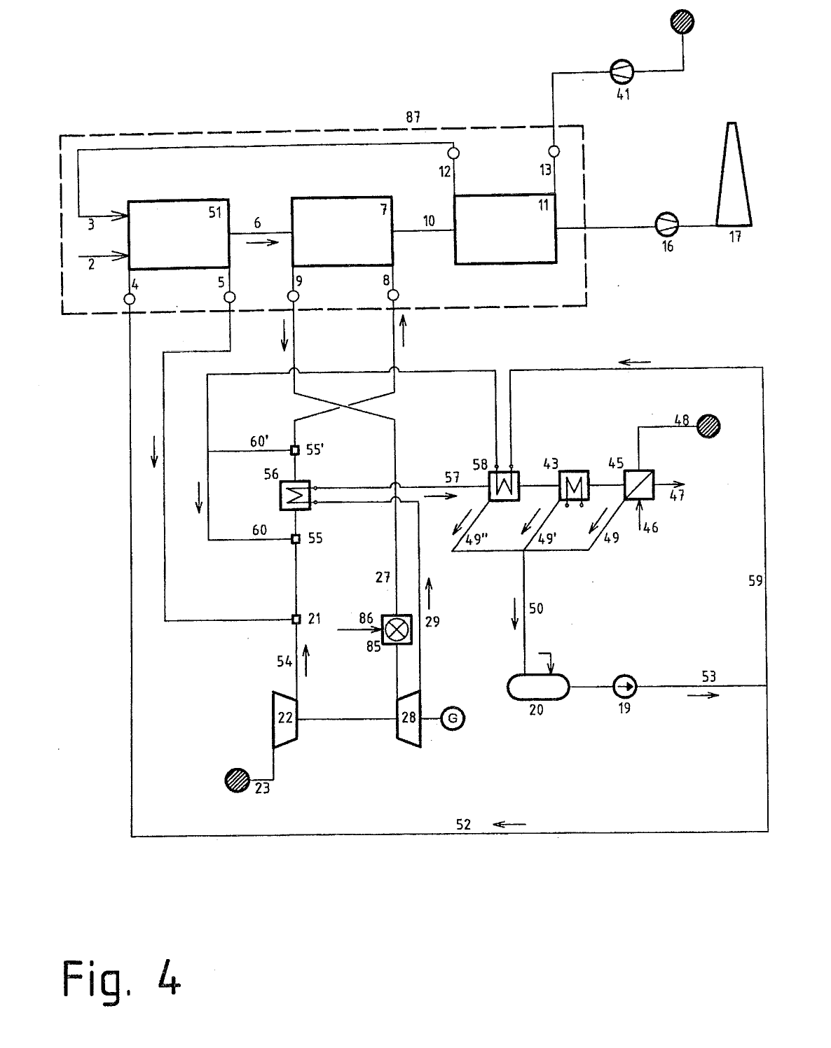

In the alternative design according to FIG. 4 the power cycle consists of a cooled heat aggregate 51, e.g. a heating furnace with evaporative cooling, but also cooled combustion chambers, with fuel supply 2 and with combustion air supply 3, further with cooling medium supply 4 and the output of the cooling medium steam 5, which is by means of a hot flue gas duct 6 connected to the steam-gas mixture heater 7 with supply 8 and outlet 9 of the steam-gas mixture, which is by means of a flue-gas duct 10 connected to combustion air heater 11 with hot air output 12 and preheated air input 13. After the combustion air heater 11, further flue-gas fan 16 and a stack 17 are connected. The cooling medium supply 4 is by means of the cooling medium supply pipe 52 connected to the cooling medium discharge pipe 53, in which is a feed pump 19, and which is connected to the cooling medium tank 20. The output of the cooling medium steam 5 is connected to the mixing piece 21, which is connected both to the output of the compressor 22 and to the steam-gas mixture inlet 8 by means of a steam-gas pipe 54, in which is the mixing cooler 55, further the regeneration exchanger 56 and the mixing cooler 55′. The outlet 9 of the steam-gas mixture is supply pipe 27, in which a gas burner 85 can be placed, connected to the input of the gas turbine 28, the output of which is by means of the output pipe 29 of the steam-gas mixture connected to the input of the regeneration exchanger 56. The regeneration exchanger is by means of the connecting pipe 57, in which are the preheater 58 of the injected medium and the warm service water heater 43, connected to the separation condenser 45, which is on the side of the operating medium output connected to the operating medium exhaust pipe 48 and on the side of the condensate to the condensate pipe 49, which is fed together with the condensate pipes 49′ and 49″ from the warm service water heater 43 and the preheater 58 of the injected medium into the condensate collecting pipe 50, which is connected to the cooling medium tank 20. The pressure pipe 59 of the injected medium is connected to the cooling medium discharge pipe 53, which is connected to the input of the preheater 58 of the cooling medium, the output of which is connected to the mixing cooler 55 and 55′ by means of injection pipes 60 and 60′.

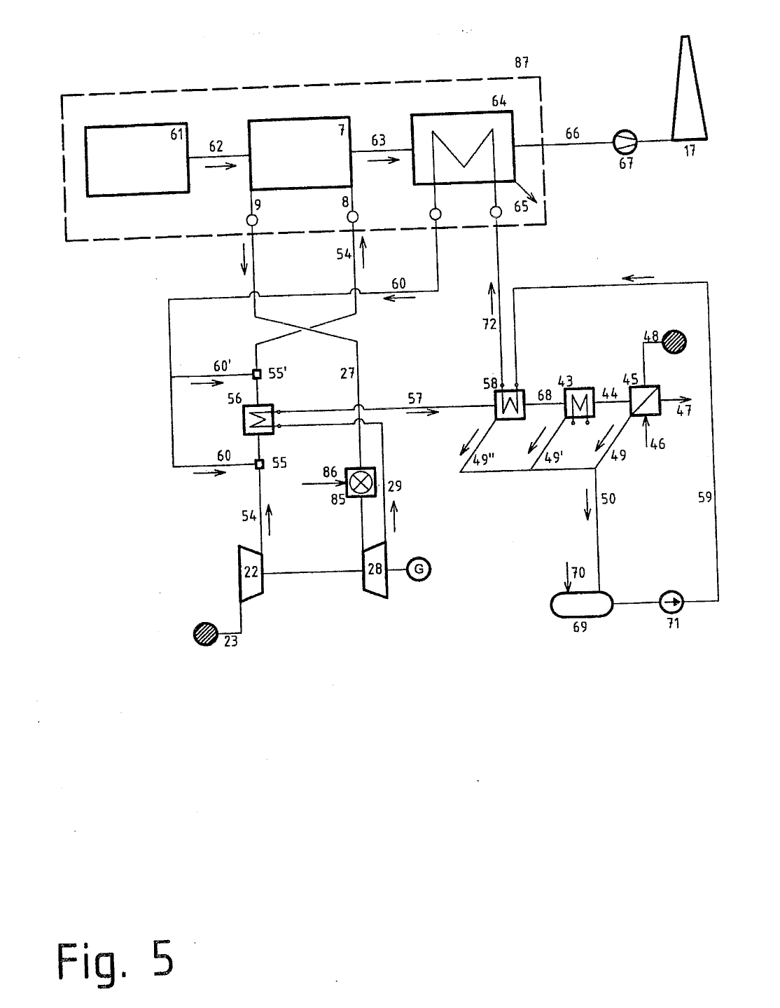

In the alternative design according to FIG. 5 the power cycle consists of the aggregate 61 producing flue gas or a mixture of gases of a necessary temperature, e.g. from a heating furnace, a high-temperature fuel cell, which is connected to the steam-gas mixture heater 7 by means of the gas duct 62, further by means of the gas pipe 63 to the injected medium heater 64 with the polluted condensate output 65 and further by means of the output duct 66 with the suction fan 67 to the stack 17. The steam-gas mixture supply 8 is by means of steam-gas pipe 54, where the mixing cooler 55′, regeneration exchanger 56 and mixing cooler 55, are connected to the output of the compressor 22 with suction pipe 23. The outlet 9 of the steam-gas mixture is by means of the supply pipe 27, in which a gas burner 85 can be placed, connected to the input of the gas turbine 28 with generator, the output of which is by means of steam-gas mixture output pipe 29 connected to the input of the steam-gas mixture into the regeneration exchanger 56, the steam-gas mixture output of which is by means of the connecting pipe 57 connected to injected medium preheater 58. The injected medium preheater is by means of the outlet pipe 68 connected to the warm service water heater 43 and by means of the outlet pipe 44 to the separation condenser 45, the operating medium output of which is connected to the operating medium exhaust pipe 48 and the output of the condensate is connected to the condensate pipe 49. This is together with the condensate pipes 49′ and 49″ from the heating service water heater 43 and the injected medium preheater 58 fed into the condensate collecting pipe 50, which is connected to the injected medium provision tank 69 with the additive injected medium inlet 70. The injected medium provision tank 69 is by means of the pressure pipe 59 with the injection pump 71 connected to the injected cooling medium preheater 58. The injected cooling medium preheater is by means of the input pipe 72 connected to the input of the injected medium heater 64, the output of which is by means of the injected medium pipes 60 and 60′ connected to mixing coolers 55 and 55′.

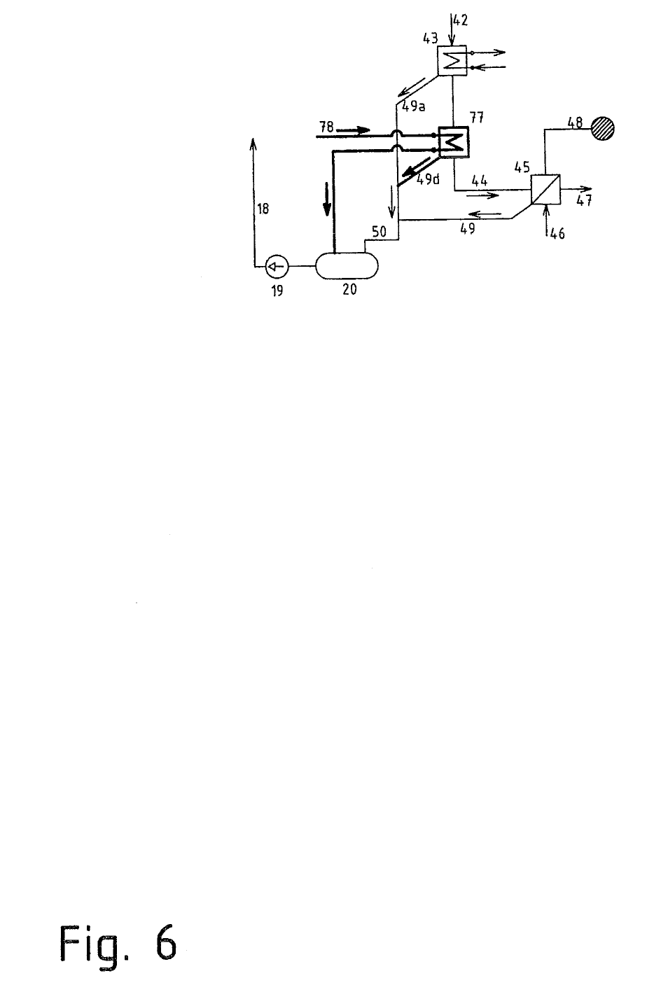

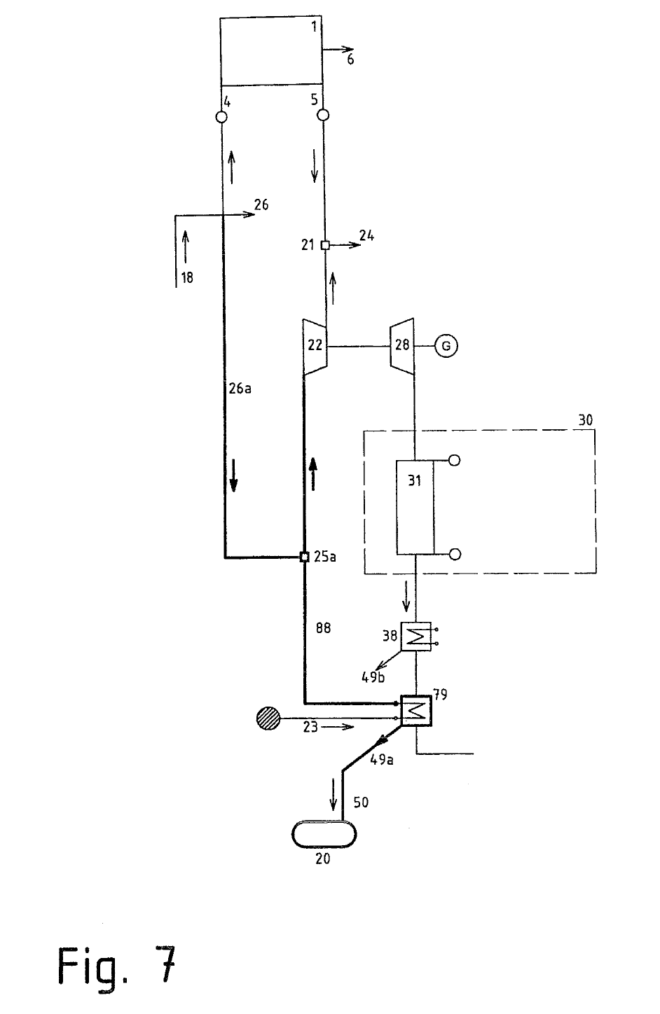

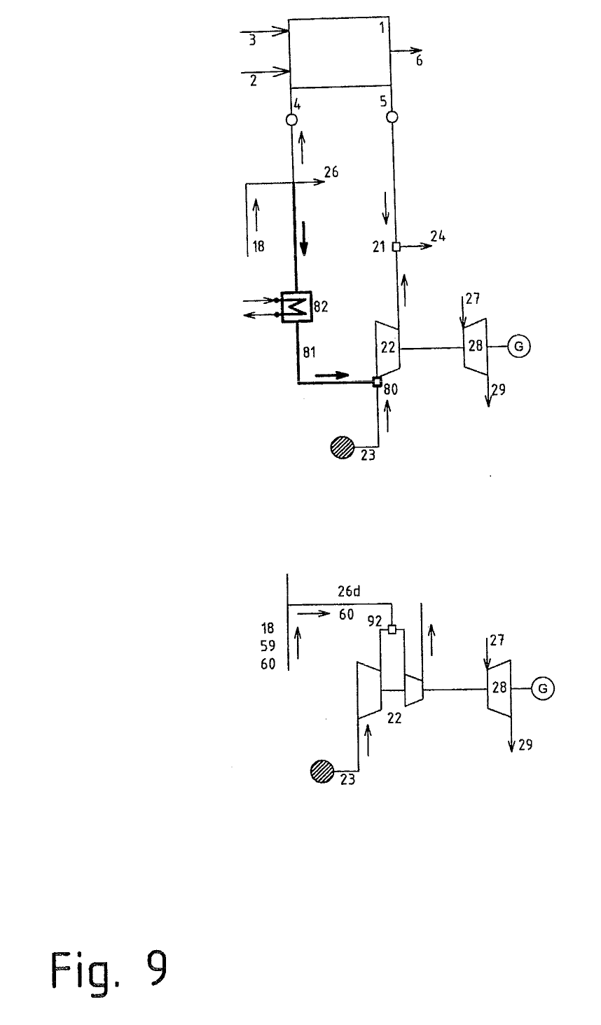

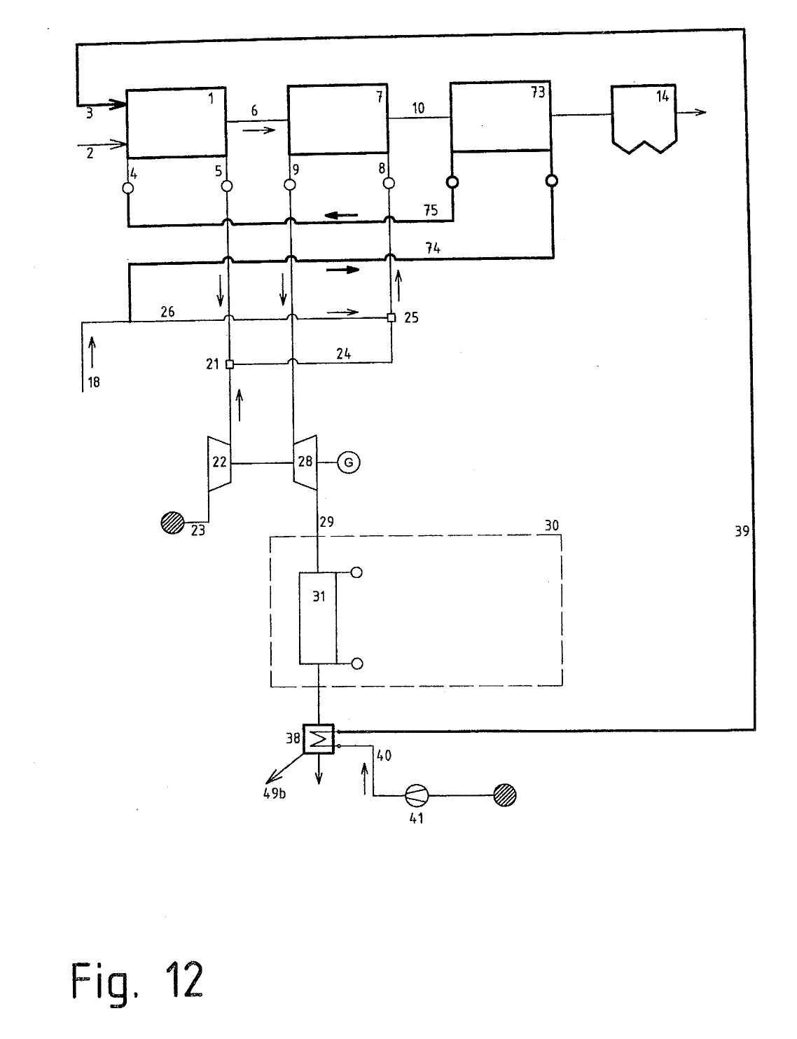

At this alternative connection at the alternative design, connections according to the alternative designs in FIG. 6 can be applied, for the preheating of the additive cooling medium from the additive medium input pipe 78, further in FIG. 7 for the preheating of air before the compressor 22, in FIG. 9 for the isothermal compression at the compressor 22 and in FIG. 12 for increasing of the temperature before the gas turbine 28.

In the alternative design according to FIG. 6 before the separation condenser 45 the heat exchanger 77 for the preheating of the additive cooling medium is located, which is on the side of the cooling medium input connected to the input pipe 78 of the additional cooling medium and on the output side of the cooling medium it is connected to the cooling medium tank 20.

In the alternative design according to FIG. 7 after the combustion air preheater 38 the heater 79 of the suction operation gas is located, which is on the side of the gas input connected to the suction pipe 23 and on the side of the gas output to the connecting pipe 88, which is connected to the compressor 22 and in which is the injection cooler 25a, which is by the pipe 26a of the injected medium connected to the cooling medium pipe 18.

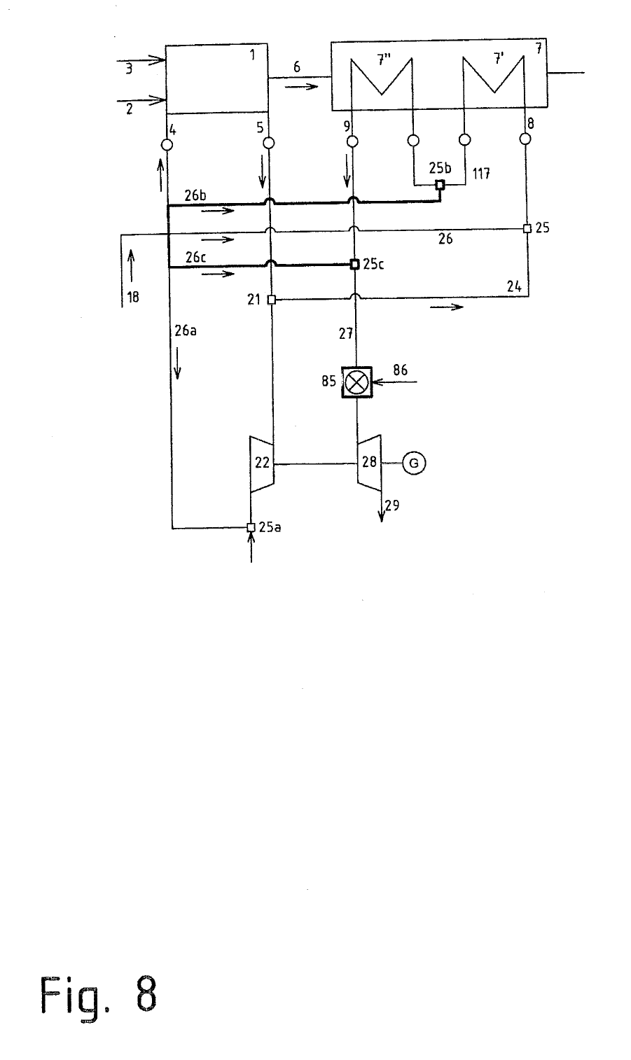

In the alternative design according to FIG. 8 the injection cooler 25b is placed between the parts 7′, 7″ of the heater 7 of the steam-gas mixture and the cooler 25c is placed in the input pipe 27, where a gas burner 85 can be placed, whereas the injection coolers are connected to the cooling medium pipe 18 by means of the injection medium pipes 26b and 26c. At the same time the steam-gas mixture heater 7 can have more parts than the presented two, e.g. membrane walls, parts of convection part of the heater, parts of the radiant part of the heater and between them more injection coolers 25b than presented can be placed.

In the alternative design according to FIG. 9 a sprayer 80 of the cooling medium for the isothermal compression is placed in the suction part of the compressor 22, which is by means of the pipe 81 of the sprayed medium, in which the heat exchanger 82 for the heating of the sprayed medium is built-in, connected to the cooling medium pipe 18 and/or according to the lower part of FIG. 9 between the single stages of the compressor 22, the number of which can be higher than suggested, the mixing intermediate cooler 92 is placed, which is by means of the cooling medium pipe 26d, eventually by means of the injection pipe 60, connected to the cooling medium pipe 18, eventually to the pressure pipe 59, eventually to the injection pipe 60.

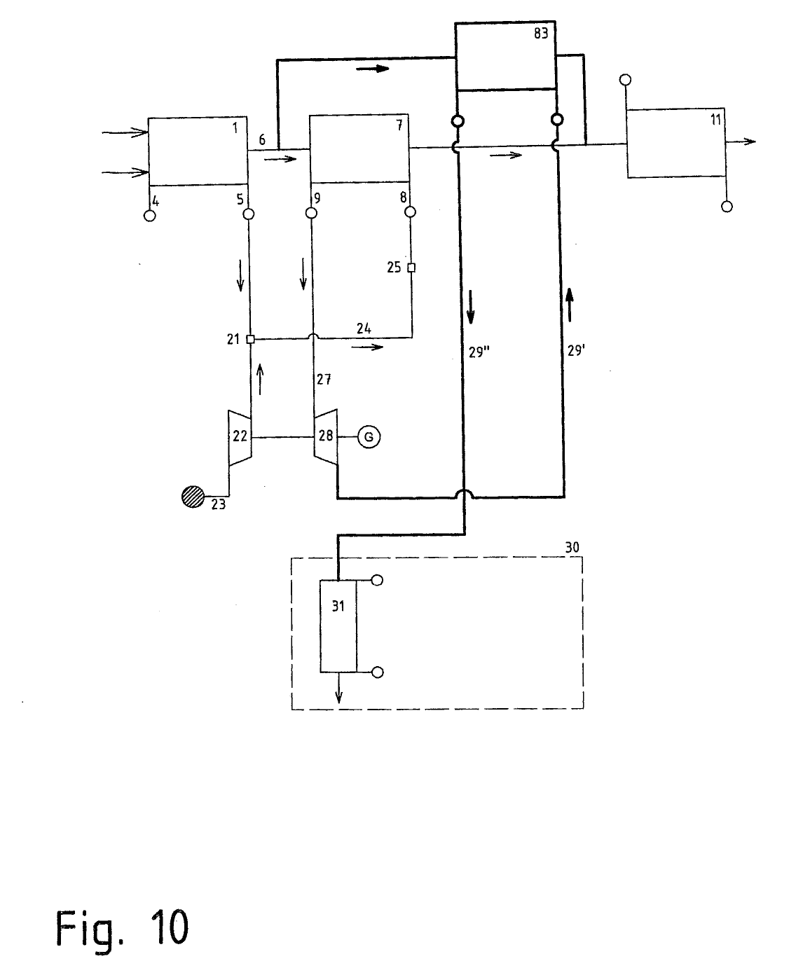

In the alternative design according to FIG. 10 in the flue gas flow from the cooled combustion chamber 1 together with the steam-gas mixture heater 7, e.g. in parallel or other way, the reheater 83 of the steam-gas mixture is located, which is on the input side by means of the output pipe 29′ connected to the output of the gas turbine 28 and on the output side by the output pipe 29″ to the input of the steam generator 31, whereas the steam-gas mixture reheater 83 can be designed of several parts.

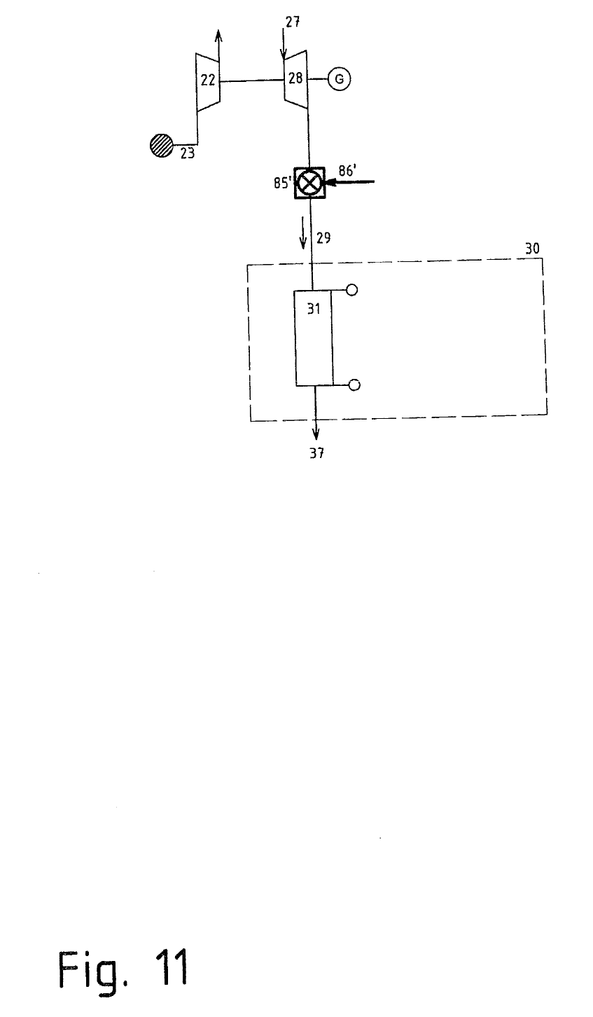

In the alternative design according to FIG. 11 in the output pipe 29 of the steam-gas mixture before the steam generator 31 the device 85′ for additive combustion is built in, e.g. a combustion chamber or a burner, which is connected to the fuel supply 86′, of gaseous or liquid fuel, e.g. of natural gas.

In the alternative design according to FIG. 12 after the heater 7 of the steam-gas mixture the flue-gas heater 73 for the cooling medium is located, which is connected by means of the connecting pipe 74 to the cooling medium pipe 18 and by means of the connecting pipe 75 to the cooling medium inlet 4 of the cooled combustion chamber 1.

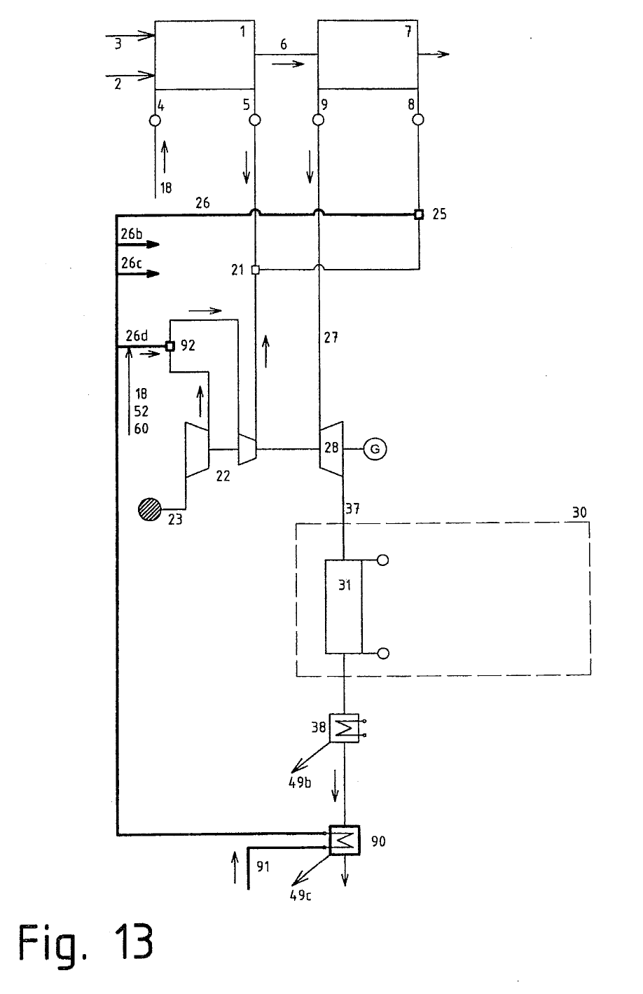

In the alternative design according to FIG. 13 in the steam-gas mixture, e.g. after the preheater 38 of the combustion air, the exchanger 90 for the heating of the injected medium is located, which is at the input of the injected medium connected to the supply pipe 91, by means of which the injected medium is supplied, e.g. cold condensate, and at the output it is connected to the injection medium pipe 26, eventually 26b, 26c, eventually to the injection medium pipe 26d, which is connected to the mixing intermediate gas coolers 92 between the single stages of the compressor 22. The intermediate mixing coolers 92 can be by means of the pipe 26d alternatively connected to the cooling medium pipe 18 or also to the pressure pipe 52 or also to the injection pipe 60.

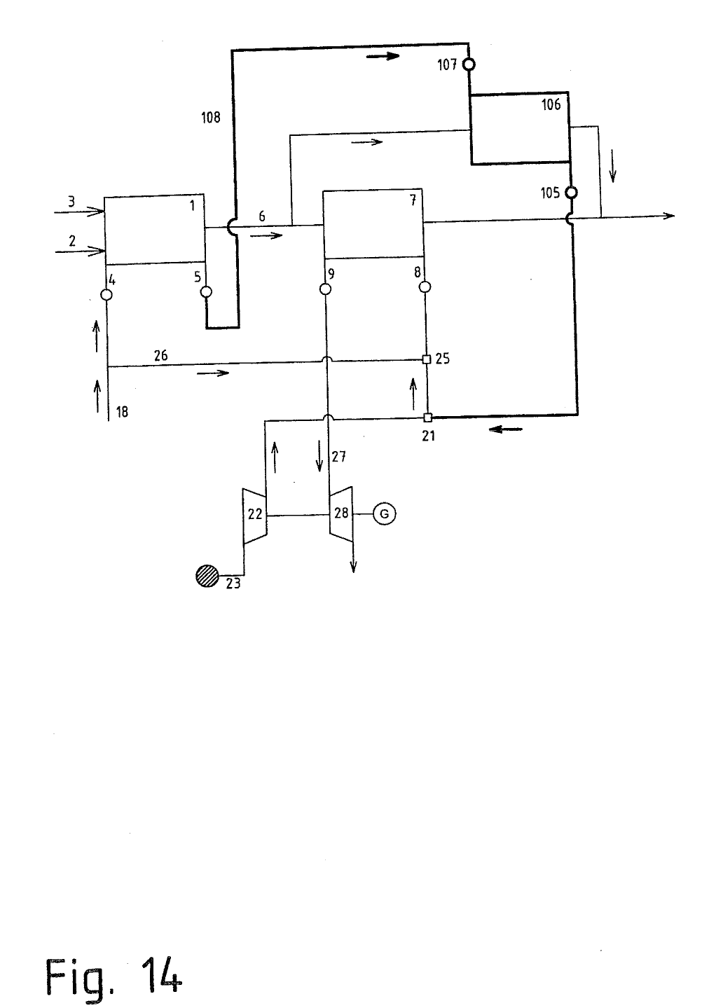

In the alternative design according to FIG. 14 in the flue gas flow after the uncooled combustion chamber 1 together with the heater 7 of the steam-gas mixture, e.g. in parallel or other way, the superheater 106 of the cooled medium steam is located, the steam input 107 of which is connected to the output 5 of the cooling medium steam from the cooled combustion chamber 1 and the cooling medium steam output 105 of which is connected to the mixing piece 21. The steam superheater 106 can be of more parts as well, which can be designed e.g. as membrane walls, suspended pipes, plate areas, serpentine systems.

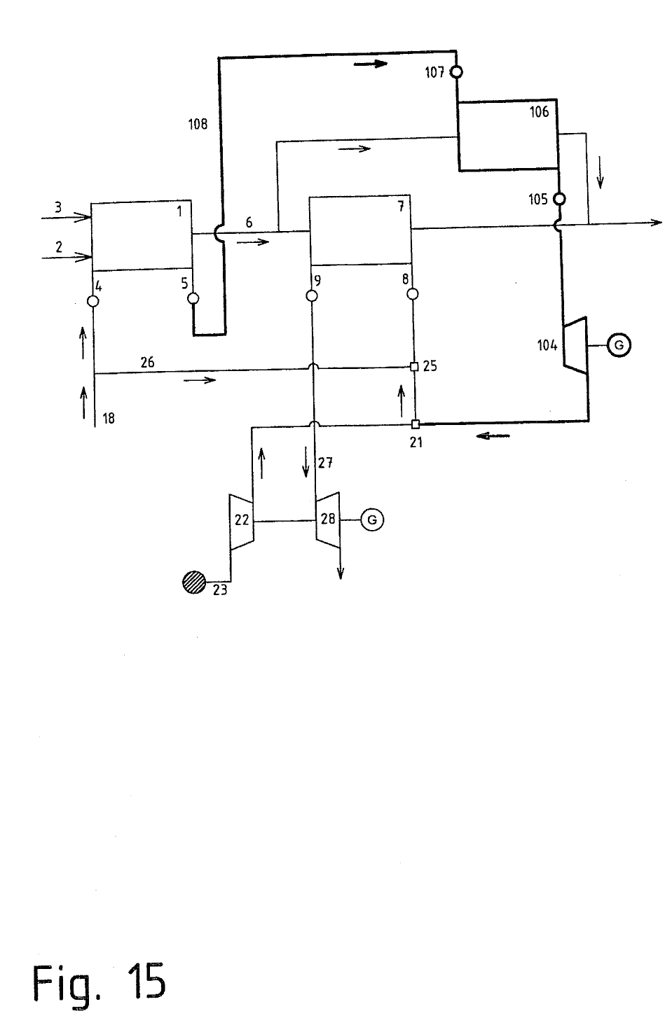

In the alternative design according to FIG. 15 the power cycle consists of the back-pressure steam turbine 104, which is at the steam output connected to the mixing piece 21 and at the steam input it is connected to the output 105 of the steam from the steam superheater 106, the steam input 107 of which is connected to the output 5 of the steam of the cooling medium from the cooled combustion chamber 1, whereas the steam superheater 106 is on the flue gas side connected in parallel to the steam-gas mixture heater 7 or to some of its parts at least, alternatively it can be connected in series to some of the parts of the steam-gas mixture heater 7, eventually in can be connected in combination of parallel as well as serial connection. The steam superheater 106 is designed in the same way as in FIG. 14, however the pressure of the steam is higher and it corresponds to the steam pressure at the input to the back-pressure steam turbine 104.

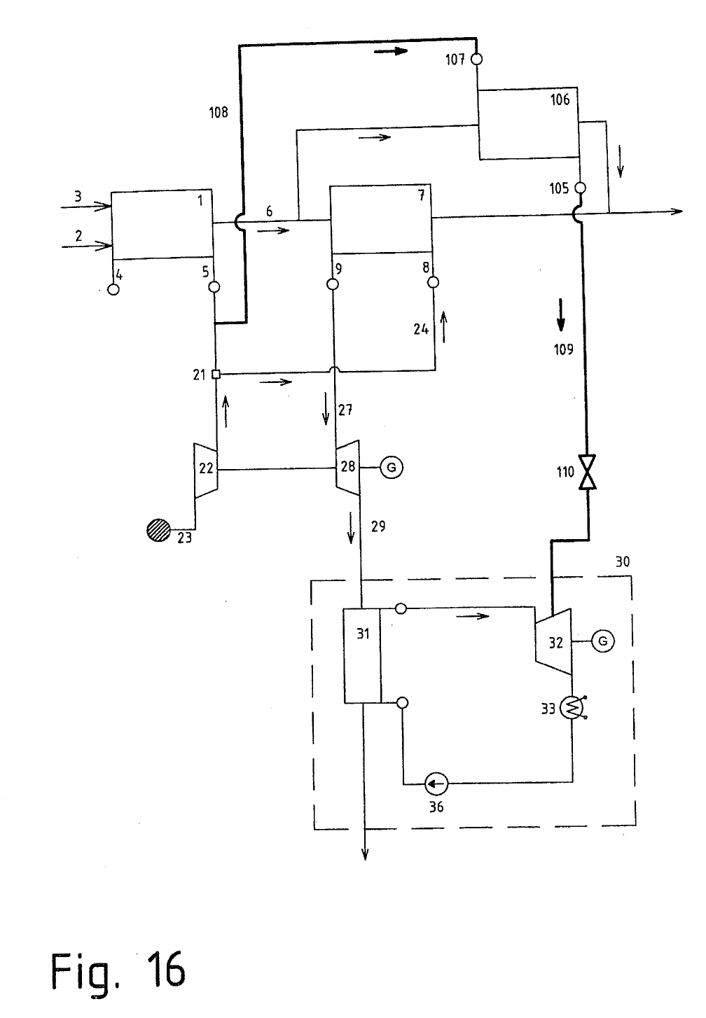

In the alternative design according to FIG. 16 the steam input 107 into the cooling medium superheater 106, which is designed e.g. according to FIG. 14, is connected by means of the supply steam pipe 108 to the installation between the cooling medium steam output 5 and the mixing piece 21, and the cooling medium steam output 105 from the cooling medium superheater 106 is by means of the output steam pipe 109, in which are flow control devices 110, connected to the steam turbine 32 of the installation 30 of the Rankine-Clausius steam cycle.

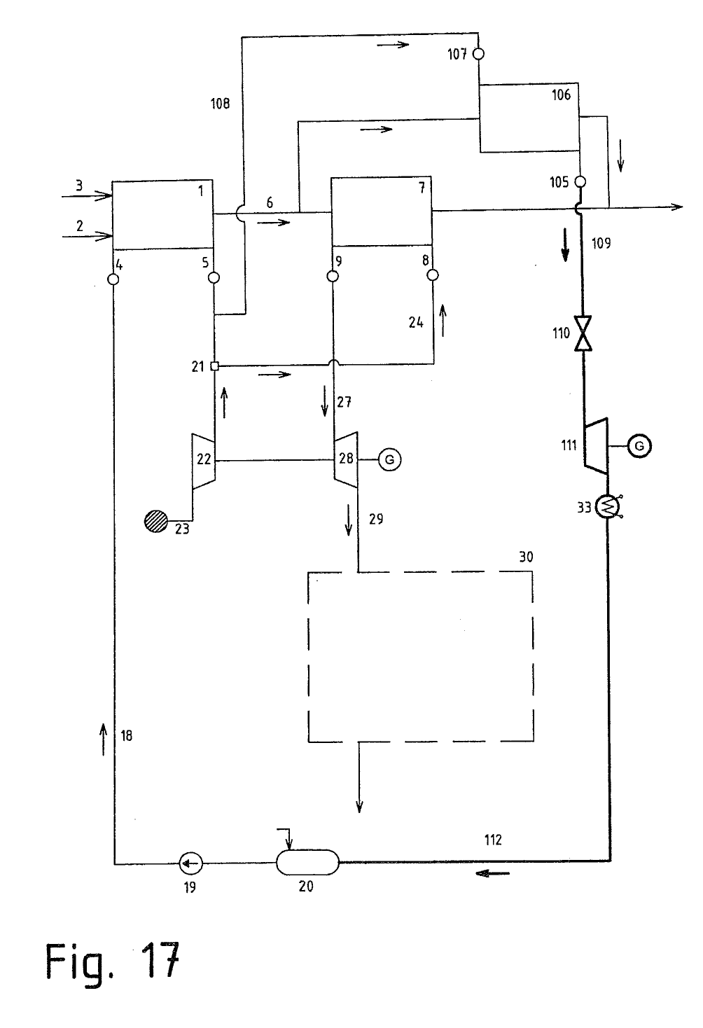

In the alternative design according to FIG. 17 the steam output 105 from the cooling medium steam superheater 106, e.g. in the design according to FIG. 14, is connected by means of the output steam pipe 109, with flow control devices 110, to the condensing steam turbine 111 with the condenser 33, the output of which is by means of the condensate pipe 112 connected to the cooling medium tank 20. The pressure of the steam on the input into the condensing steam turbine 111 corresponds to the pressure of the gas after the compressor 22.

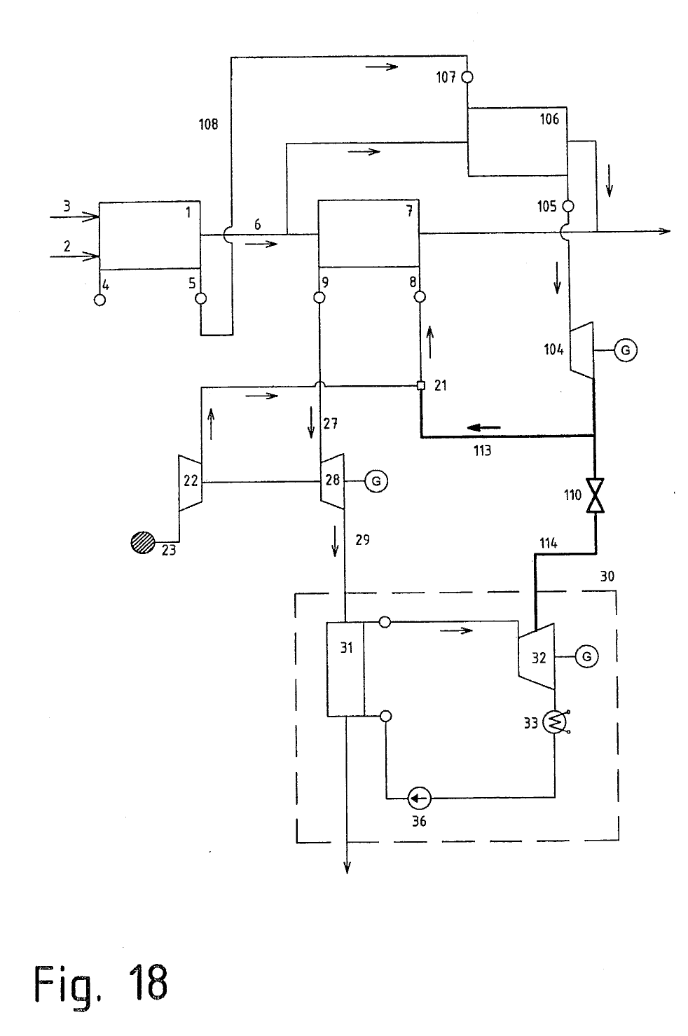

In the alternative design according to FIG. 18 the output from the back-pressure turbine 104, in the design e.g. according to FIG. 15 is connected by means of main pipe 113 to the mixing piece 21 and by means of the branching pipe 114, with flow control devices 110, to the steam turbine 32 of the installation 30 of the Rankine-Clausius cycle. At the output of the back-pressure turbine 104 is a pressure that corresponds to the pressure of the gas after the compressor 22.

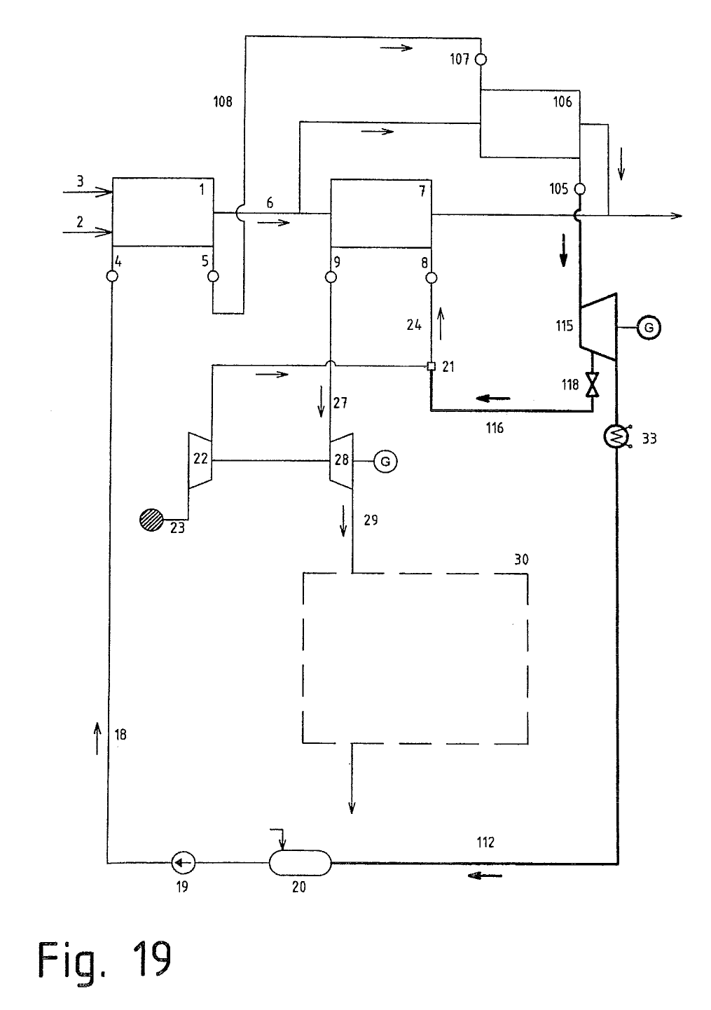

In the alternative design according to FIG. 19 the steam output 105 from the cooling medium steam superheater 106, in the design e.g. according to FIG. 15, is connected to the condensing turbine 115 with the controlled extraction 118, which is by means of the extraction pipe 116 connected to the mixing piece 21 and the output of the condenser 33 is by means of the condensate pipe 112 connected to the cooling medium tank 20. The pressure on the input into the condensing turbine 115 is higher than the pressure of the gas on the output from the compressor 22 and the pressure in the controlled extraction 118 corresponds to this pressure.

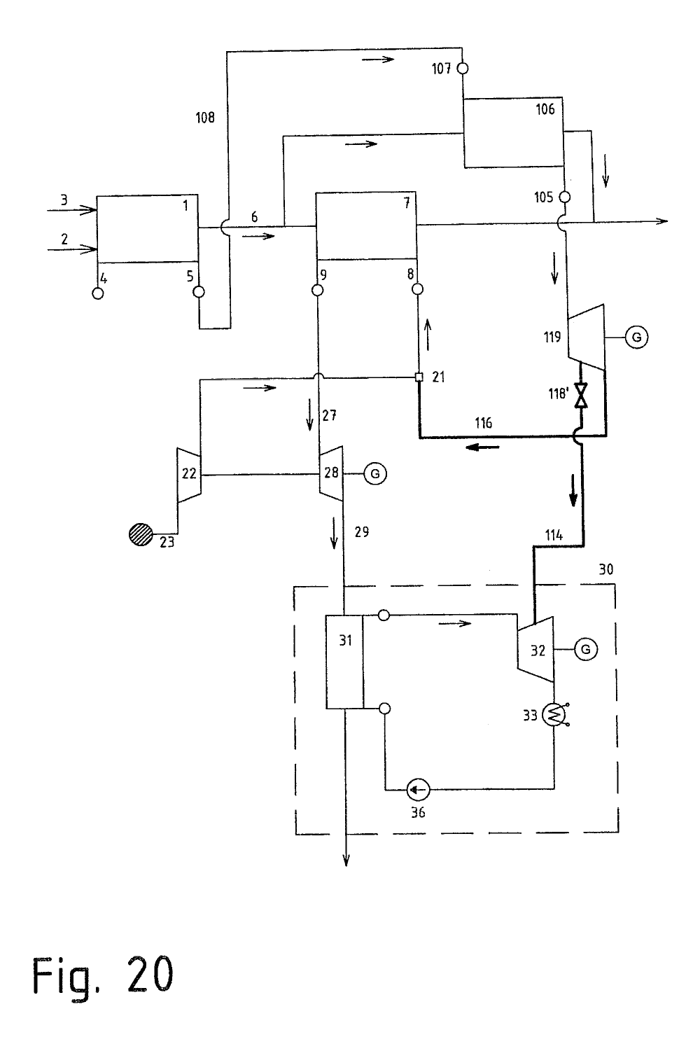

In the alternative design according to FIG. 20 the steam output 105 from the cooling medium steam superheater 106, e.g. in the design according to FIG. 15, is connected to the back-pressure turbine 119 with controlled extraction, the output of which is by means of the extraction pipe 116 connected to the mixing piece 21 and the controlled extraction 118′ is by means of the branching pipe 114 connected to the steam turbine 32 of the installation 30 of the Rankine-Clausius cycle. The pressure at the input of the back-pressure turbine 119 as well as the pressure in the controlled extraction is higher than the pressure of the gas at the output from the compressor 22, the pressure on the output from the back-pressure turbine 119 corresponds to the pressure on the output from the compressor 22.

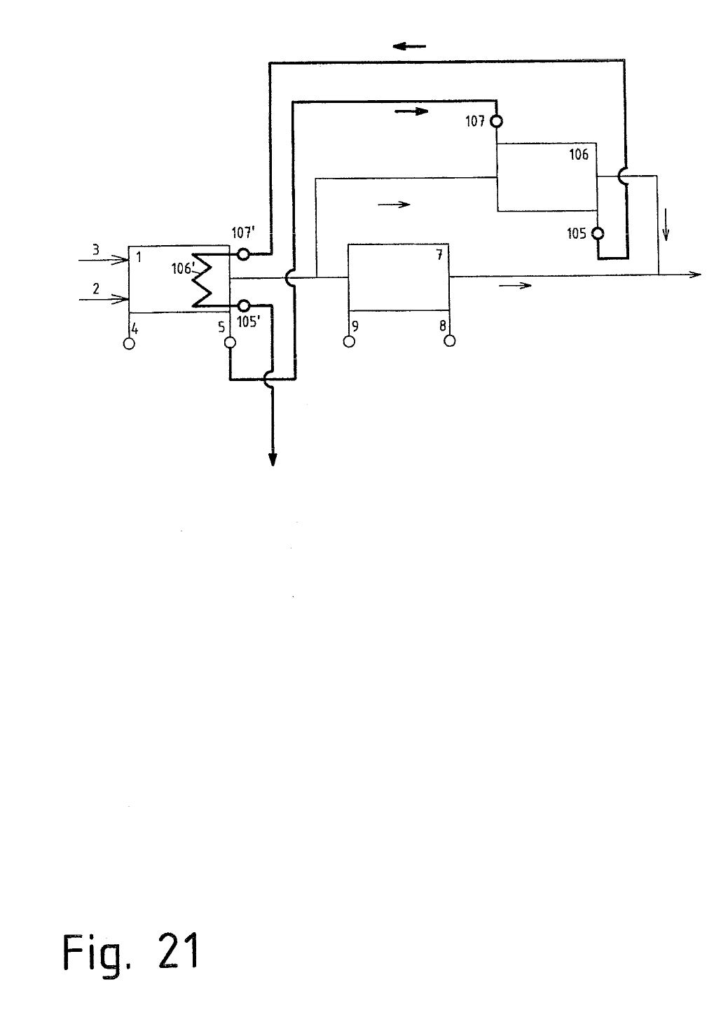

In the alternative design according to FIG. 21 the cooling medium steam superheater 106, e.g. according to FIG. 14 as well as FIG. 15, can be designed of more parts, whereas at least one of its parts 106′, e.g. the output part, is placed in the cooled combustion chamber 1 and the input 107 of the steam superheater 106 is connected to the steam output 5 of the cooled combustion chamber 1 and its steam output 105 from the previous part is connected to the input 107′ of the output part of the superheater 106′, the output 105′ of which can be connected to the mixing piece 21 or to the back-pressure turbine 104 or to the steam turbine 32 or to the condensing turbine 111 or to the condensing turbine 115 with controlled extraction or to back-pressure turbine 119 with controlled extraction.

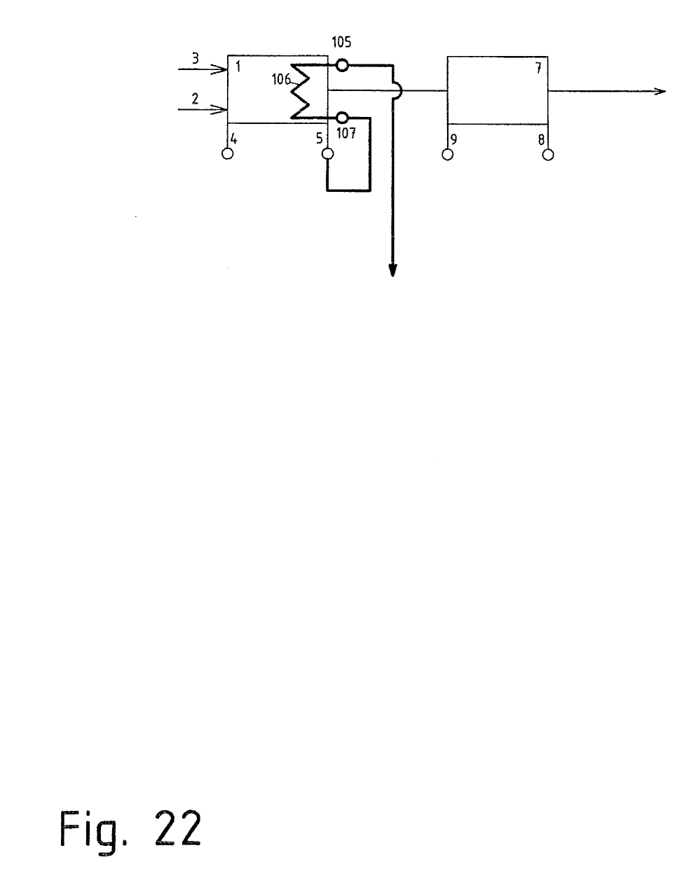

In the alternative design according to FIG. 22 the whole cooling medium steam superheater 106 placed in the cooled combustion chamber 1 and its input 107 are connected to the cooling medium steam output 5 from the cooled combustion chamber 1 and its cooling medium steam output 105 can be connected to the mixing piece 21 or to the back-pressure turbine 104 or to the steam turbine 32 or to condensing turbine 111 or to condensing turbine 115 with controlled extraction or to back-pressure turbine 119 with controlled extraction.

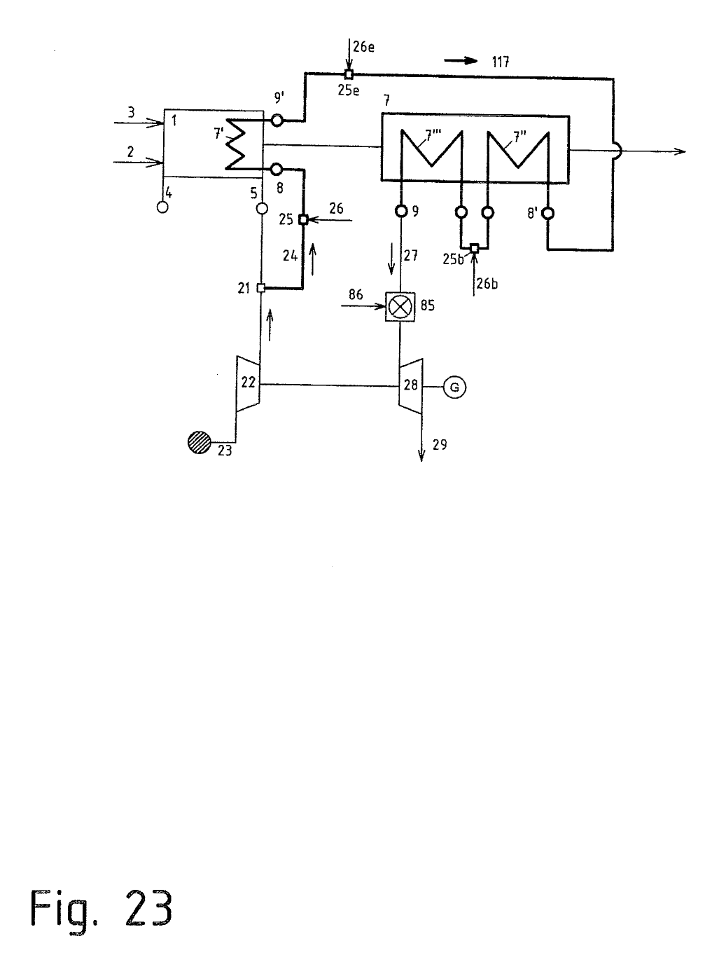

In the alternative design according to FIG. 23 the steam-gas mixture heater 7 is divided into more parts, e.g. 7′, 7″, and 7′″, whereas its input part 7′ is placed in the cooled combustion chamber 1 and its steam-gas mixture input 8 is by means of the connecting pipe 24, in which the injection cooler 25 can be placed, connected to the mixing piece 21 and its steam-gas mixture outlet 9′ is by means of the inner pipe 117, in which an injection cooler 25e can be placed, connected to the steam-gas mixture inlet 8′ of the subsequent part 7″ of the steam-gas mixture heater 7. The steam-gas mixture is after the injection cooler 25b led to the output part 7′″ of the steam-gas mixture heater, the steam-gas mixture outlet 9 is by means of supply pipe 27, in which a device 85 for additional combustion of gas can be placed, connected to the steam turbine 28.

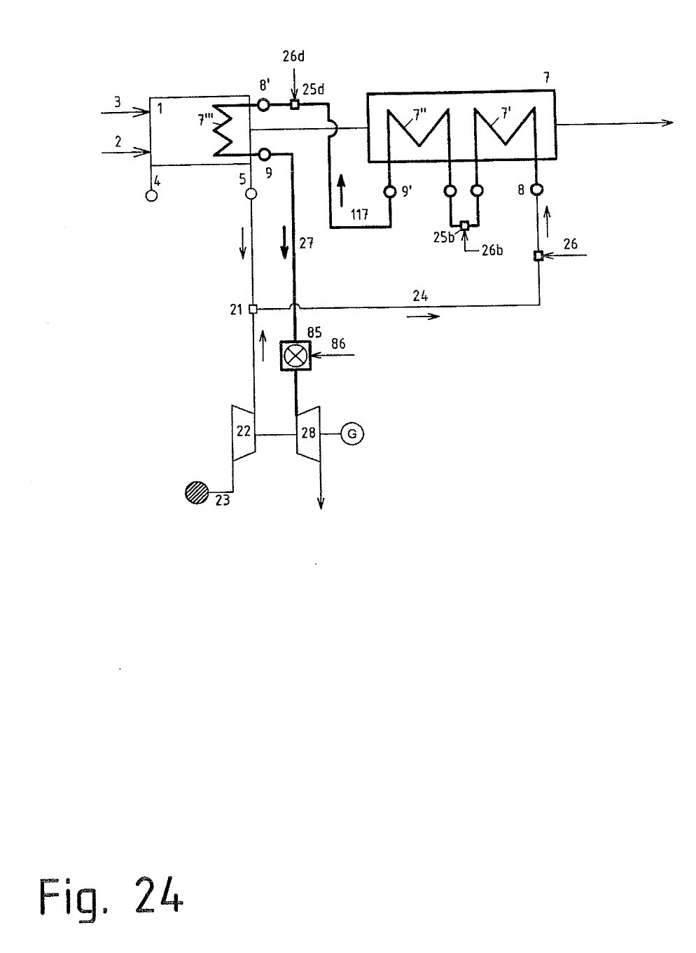

In the alternative design according to FIG. 24 is the steam-gas mixture heater 7 divided into more parts, e.g. 7′, 7″, and 7′″, whereas its output part 7′″ is placed in the cooled combustion chamber 1 and its steam-gas mixture input 8 is by means of the inner pipe 117, in which the injection cooler 25d may be placed, connected to the steam-gas mixture outlet 9′ from the previous part 7″ of the steam-gas mixture heater 7, whereas its outlet 9 of the steam-gas mixture is by means of the supply pipe 27, in which a device 85 for additional combustion of gas can be placed, connected to the steam turbine 28.

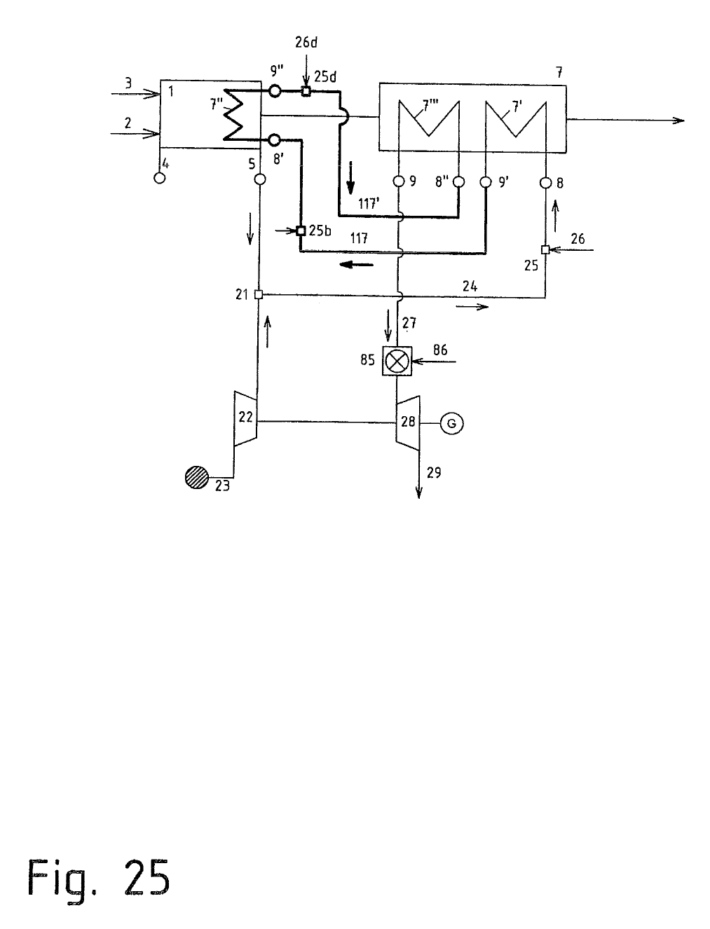

In the alternative design according to FIG. 25 the steam-gas mixture heater 7 is divided into more parts, e.g. 7′, 7″, and 7′″, whereas one of its inner parts, e.g. 7″, is placed in the cooled combustion chamber 1 and its steam-gas mixture input 8′ is by means of the inner pipe 117, in which the injection cooler 25b can be placed, connected to the steam-gas mixture outlet 9′ from the previous part 7′ of the steam-gas mixture heater 7 and its steam-gas mixture outlet 9″ is by means of the inner pipe 117′, in which the injection cooler 25d can be placed, connected to the steam-gas mixture inlet 8″ of the subsequent part 7′″ of the steam-gas mixture heater 7, the steam-gas mixture outlet 9 of which is by means of supply pipe 27, in which a device 85 for additional combustion of gas can be placed, connected to the gas turbine 28.

In the power cycle according to the design in FIG. 1 as primary power source fuels are used like fossil fuels, e.g. coal as well as alternative fuels, e.g. biomass, also wastes, which are supplied by means of the fuel supply 2 into the cooled combustion chamber 1. The combustion chamber is of common construction, applicable for the combustion of the mentioned fuel with e.g. stoker fired, pulverized fuel, gas, oil, or fluidized bed furnace, with the combustion with air or oxygen, eventually with any suitable furnace, the walls of which are cooled by the evaporation of cooling medium, e.g. treated water. The size of the combustion chamber is designed in such a way that the flue gas temperature on its output is the highest but not exceeding the ash fusing point, e.g. 1100° C. Regarding the emissions, for the reduction of the generation of harmful substances and of their amount commonly used precautions are implemented at the applied furnace type. The flue gas is further significantly cooled to the output temperature from the steam-gas generator 87 to the stack 17 in the steam-gas mixture heater 7.

The cooling medium for the cooling of the combustion chamber 1 is extracted from the cooling medium tank 20 and is by means of the feed pump 19 and the cooling medium pipe 18 forwarded to the cooling medium supply 4 and the generated steam extracted from the cooling medium output 5 is in the mixing piece 21 mixed with pressure air from the compressor 22, that means that the pressure in the cooling system of the cooled combustion chamber 1 is in compliance with the output pressure of the compressor 22.

The generated steam-gas mixture is led by means of the connecting pipe 24 to the steam-gas mixture heater 7, the heat transfer surface of which can be divided into more parts, where it is heated to the minimum temperature suitable for the gas turbine 28, which is e.g. at least 800° C. up to 950° C., according to the combusted fuel in the cooled combustion chamber 1. Before the input of the steam turbine 28 the steam-gas mixture can be heated in the device 85 for additional burning of fuel, e.g. natural gas, to a higher temperature, e.g. 1200° C. up to 1300° C.

After the expansion in the steam turbine 28 the heat of the steam-gas mixture is further utilized in the installation 30 of the Rankine-Clausius cycle for gaining of further power, specifically in the heat recovery steam generator 31 (HRSG), in which the produced steam is further utilized in the steam turbine 32 and the developed low-temperature condensate is by means of the feeding pump 36 fed from the condenser 33 back into the steam generator 31.
Owing to the low temperature of the fed condensate a part of the steam from the steam-gas mixture at the cold end of the steam generator 31 can condense, in that case the condensate can be led by means of the pipe 49c through the collecting pipe 50 into the cooling medium tank 20.

In the power cycle according to the exemplary design in FIG. 2 as source of primary power the sensible heat of waste gas or a mixture of gases of various, mostly uncooled, aggregates 61 is utilized, e.g. furnaces, high-temperature fuel cells, piston engines. This sensible heat is utilized in the steam-gas mixture heater 7 for the heating of the steam-gas mixture to operating temperature of the gas turbine 28.

The air from the compressor 22 is led to the supply 8 of the steam-gas mixture heater 7, whereas it is step by step at first cooled by evaporation of the injected medium in the mixing cooler 55 to minimum closely above the dew point of the developed steam-gas mixture, after that the developed steam-gas mixture is heated in the regeneration exchanger 56 and is subsequently cooled down by evaporating of the injected medium in the mixing cooler 55′, but again to minimum above the dew point of the steam contained in the mixture.
The steam-gas mixture generated in this way heats up in the steam-gas mixture heater 7 to the necessary temperature for the gas turbine, e.g. 800° C. or it heats up to the maximum possible temperature, and to the temperature necessary for the gas turbine 28 it heats up in the device 85 for the additional burning of fuel, e.g. natural gas and after the expansion in the gas turbine 28 a considerable part of the residual heat of the steam-gas mixture is before the outlet of the exhaust pipe 48 utilized to its preheating in the regeneration exchanger 56.

In the power cycle according to alternative design in FIG. 3 the primary source of power is the combusted fuel similarly to the exemplary design according to FIG. 1.

The flue gas leaving the cooled combustion chamber 1 is further significantly cooled in the steam-gas mixture heater 7 and it cools down to the output temperature from the steam-gas generator 87 in the combustion air heater 11.

The flue gas exhaust into the stack 17 is arranged by means of the flue-gas fan 16, the flue gas treatment takes place in a separator (or a filter) 14 of solid pollutants and in the flue gas cleaning facility 15.
The combustion air drawn by the combustion air fan 41 is warmed up in the combustion air preheater 38 to the necessary temperature at least for the elimination of low temperature corrosion of the combustion air heater 11 and it is heated to the necessary temperature for the combustion in the combustion air heater 11, eventually the temperature of the heating of the air is chosen for the reaching of the necessary flue-gas temperature after the steam-gas mixture heater 7.
The cooling medium for the cooling of the combustion chamber 1 is taken from the cooling medium tank 20 and is by means of the feed pump 19 and by means of pipe 18 forwarded to the cooling medium inlet 4 and the generated steam drained from the output of the cooling medium 5 is in the mixing piece 21 mixed with pressure air from the compressor 22, that means that the pressure in the cooling system of the cooled combustion chamber 1 is in compliance with the output pressure of the compressor 22.
The generated steam-gas mixture is in the injection cooler 25 cooled down by means of a cooling medium, which is extracted by means of the injected medium pipe 26 from the cooling medium pipe 18 to necessary temperature, which is lower than the temperature of the flue gas leaving the steam-gas mixture heater 7, but it must be higher than the dew point of the steam in the forwarded steam-gas mixture and cooled in this way it is led to the steam-gas mixture inlet 8 of the steam-gas mixture heater 7.
In the steam-gas mixture heater 7, the heat-exchanging surface of which can be divided into more parts, the steam-gas mixture is heated to a temperature suitable for the steam turbine 28, e.g. to 800° C., or it is heated to the maximum possible temperature and to the necessary temperature for the gas turbine it is heated in the installation 85 for the additional burning of fuel, e.g. natural gas, and at this temperature it is led to the input of the gas turbine 28 with generator.
After the expansion in the gas turbine 28 the heat of the steam-gas mixture is further utilized in the installation 30 of the Rankine-Clausius cycle for gaining of further power, concretely into the heat recovery steam generator 31. The steam produced in the heat recovery steam generator is utilized in the steam turbine 32 and the developed low-temperature condensate is by means of the feeding pump 36 fed from the condenser 33 back into the steam generator 31.

Owing to the low temperature of the condensate a part of the steam from the steam-gas mixture at the cold end of the steam generator 31 can condense, in that case the developed condensate is drained by the condensate pipe 49c into the condensate collecting pipe 50.

Further utilization of the residual heat of the steam-gas mixture and gaining of further condensate takes place in the combustion air preheater 38, in which the combustion air is preheated at least to the necessary temperature for the elimination of low-temperature corrosion at the combustion air heater 11, but first of all a further part of the steam from the steam-gas mixture condenses here.
The condensate is drained by means of condensate pipe 49b into the condensate collecting pipe 50 and the residual heat of the outgoing steam-gas mixture from the combustion air preheater 38 is further partly utilized for the heating of the heating service water in the heating service water heater 43, which is included only if warm service water is required.
The generated condensate is drained by means of condensate pipe 49a into the condensate collecting pipe 50 and the remaining steam-gas mixture from the warm service water heater 43 is led into the separation condenser 45, in which the possible remaining part of steam condenses.
The generated condensate is by means of the condensate pipe 49 drained to the condensate collecting pipe 50, by means of which it is forwarded into the cooling medium tank 20 and the separated operating medium (humid air) is by means of the operating medium exhaust pipe 48 discharged into atmosphere.
The separation condenser 45 is included only in case if the steam amount in the steam-gas mixture after the warm service water heater 43, eventually after the combustion air preheater 38 in case of absence of the heater 43, is noticeably higher than the steam amount in the air drawn by means of the suction pipe 23 and therefore the operating costs on the addition of the cooling medium into the tank 20 are high. As cooling medium supplied to the cooling medium input 46 of the separation condenser 45 e.g. air can be utilized.

In the power cycle according to the exemplary design in FIG. 4 in the cooled heat aggregate 51, that can be e.g. a heating furnace with evaporative cooling or also a cooled gas combustion chamber used as a generator of hot gas, fuel supplied by means of the fuel inlet 2 is combusted with combustion air, which is heated to the necessary temperature by flue gas in the combustion air heater 11 and is supplied by the combustion air inlet 3.

The eventual protection of the combustion air heater 11 against low-temperature corrosion is realized in a common way, e.g. by means of air preheating before the input 13 of the preheated air by extracted steam, or by recirculation of the heated air from the output 12 of the hot air into the suction or to the discharge of the combustion air fan 41, eventually by a combination of these ways.

The flue gas from the cooled heat aggregate 51, which is exhausted to the stack 17 by means of the flue-gas fan 16, is significantly cooled in the steam-gas mixture heater 7 and it is then cooled to the outlet temperature from the steam-gas generator 87 in the combustion air heater 11.

The cooling medium is from the cooling medium tank 20 forwarded by means of the feed pump 19 to the cooling discharge pipe 53, from which a part is then led by means of the supply pipe 52 to the inlet 4 of the cooling medium and after its evaporation in the cooled heat aggregate 51 the steam is led to the mixing piece 21, in which it is mixed with the air from the compressor 22 and the generated steam-gas mixture is by means of the steam-gas pipe 54 led to the steam-gas mixture inlet, whereas at first it is cooled down in the mixing cooler 55, but to minimum closely above the dew point of the steam in the developed steam-gas mixture, subsequently it is heated in the regeneration exchanger 56 and in the following mixing cooler 55′ it is cooled again, to a temperature lower than the temperature of the flue gas leaving the steam-gas mixture heater 7, but to minimum closely above the dew point of the steam in the forwarded steam-gas mixture.
In the steam-gas mixture heater 7, which is designed of more parts, the steam-gas mixture is heated by flue gas to suitable temperature for the steam turbine 28, e.g. to 800° C. or it is heated to a maximum temperature and to the necessary temperature for the gas turbine it is heated in the device 85 for the additional combustion of fuel, e.g. natural gas, and after the expansion in the gas turbine 28 a considerable part of its residual heat is further used in the regeneration exchanger 56 for preheating of the steam-gas mixture, whereupon after the cooling to minimum temperature further part of its residual heat is utilized in the injected medium preheater 58, in which by condensing of a part of the steam from the steam-gas mixture further condensate is acquired, which is by means of the condensate pipe 49″ led to the condensate collecting pipe 50.
The rest of the residual heat of the steam-gas mixture is utilized for the heating of warm service water in the heating service water heater 43, whereas a further part of condensate is acquired by condensing of a part of steam from the steam-gas mixture, which is by means of pipe 49′ drained to the condensate collecting pipe 50. The heater 43 of the heating service water is included only in case the warm water supply is required.
The eventual rest of the steam from the steam-gas mixture is condensed in the separation condenser 45 by cooling medium, e.g. by the air, and the developed condensate is by means of condensate pipe 49 led to the condensate collecting pipe 50, whereas the operating medium with the rest of steam (humid air) is by means of the operating medium exhaust pipe 48 discharged into the atmosphere.
The separation condenser 45 is applied, like in the exemplary design according to FIG. 3, only if it is necessary to reduce the operation costs on make up water supply.

The developed condensate is by means of the condensate collection pipe 50 led to the cooling medium tank 20 and its part is drawn off the discharge pipe 53 as injection medium and it is by means of pressure pipe 59 led into the injected medium preheater 58, where it is heated and it is injected into the mixing coolers 55 and 55′ by means of the injection pipes 60 and 60′.

In the power cycle in the exemplary design according to FIG. 5 as source of power the sensible heat of waste gas or gas mixtures from various mostly uncooled aggregates 61, e.g. furnaces, high-temperature fuel cells, piston engines is utilized. Major part of the sensible heat is used in the steam-gas mixture heater 7 for its heating to operating temperature of the gas turbine 28 and the rest part of the sensible heat of waste gas is used for preheating of the injected medium in the injected medium heater 64.

The eventually developed condensate of water steam contained in the flue gas is led through the condensate output 65 and is further utilized according to its grade of pollution.
The air from the compressor 22 is by means of steam-gas pipe 54 led to the steam-gas mixture inlet 8, whereas at first it is step by step cooled by the evaporation of the injected cooling medium in the mixing cooler 55 to minimum closely above the dew point of the steam contained in the developed steam-gas mixture, then the developed steam-gas mixture is heated in the regeneration exchanger 56 and subsequently it is cooled by evaporation of the injected cooling medium in the mixing cooler 55′ to a temperature lower than the waste gas temperature at the output of the steam-gas mixture heater 7, but minimum closely above the dew point of the steam contained in the mixture.
In the heater 7 of the steam-gas mixture, which can be designed of more parts, the steam-gas mixture is heated to the operation temperature of the gas turbine 28, e.g. to 800° C. or it is heated to a maximum temperature and to the necessary temperature for the gas turbine 28 it is heated in the device 85 for additive combustion of fuel, e.g. natural gas, and after the expansion in the gas turbine 28 considerable part of the residual heat of the steam-gas mixture is utilized to its preheating in the regeneration exchanger 56. Another part of the residual heat is utilized for the preheating of the injected medium in the injected medium preheater 58, where part of the steam condenses and the developed condensate is by means of the condensate pipe 49″ led to the condensate collecting pipe 50 and the rest part of sensible heat of the steam-gas mixture is utilized in the heating service water heater 43, which is included only in case the heating service water is required.
The developed condensate is by means of pipe 49′ drained to the condensate collecting pipe 50 and the remaining part of the steam-gas mixture is led to the separation condenser 45, in which the eventual remaining part of the steam condenses and the developed condensate is led by means of the condensate pipe 49 into the condensate collecting pipe 50 and the remaining operation medium with the remaining amount of steam is by means of the operating medium exhaust pipe 48 discharged into the atmosphere.
The separation condenser 45, like in the exemplary design according to FIG. 3 and FIG. 4, is included only if it is necessary to reduce the operation costs on the make up injected medium supply.
The separated condensate is by means of the condensate collecting pipe 50 led to the reservoir 69 of the injected medium and by means of the injection pump 71 it is forwarded through the injected medium preheater 58 and injected medium heater 64 to the mixing cooler 55 and 55′.

The connection of the power cycle in the exemplary design according to FIG. 6 is utilized especially in case the additive cooling medium must be continuously added to the cooling medium tank 20. The residual waste heat of the steam-gas mixture before the separation condenser 45 is thus partly utilized for the preheating of the cooling medium in the tank 20 and mainly further condensate is acquired by condensation of part of steam from the steam-gas mixture. The condensate is then drained by means of pipe 49d, so the consumption of the additive cooling medium is reduced.

In the connection of the power cycle in the exemplary design according to FIG. 7 for the utilization of the steam-gas mixture waste heat, e.g. after the combustion air preheater 38, suction air heater 79 is included, in which the temperature of the suction air can be increased to such a value, at which the steam from the steam-air mixture still condenses and at which by means of its cooling in the injection cooler 25a during evaporation of all the injected medium from the pipe 26a at the input of the compressor 22, a temperature maximum approximating the temperature of the drawn air in the suction pipe 23 is reached.

The condensate developed during the cooling of the steam-gas mixture in the suction operation gas heater 79 is led by the condensate pipe 49a through condensate collecting pipe 50 to the cooling medium tank 20.

In the power cycle in the exemplary design in FIG. 8 for the reduction of the temperature of the steam-gas mixture besides the already named injection coolers 25 and 25a other injection coolers 25b are applied, which are located as necessary in the inner pipes 117 between the separate parts of the steam-gas mixture heater 7, which serve for the regulation of the steam-gas mixture temperature in chosen parts 7′, 7″ of the heater 7, and further the injection cooler 25c, which is utilized for possible control of parameters of the steam-gas mixture at the output from the steam-gas mixture heater 7 (the temperature and steam content in the mixture before the gas turbine).

In the power cycle in the exemplary design in FIG. 9 connection for isothermal compression is applied at the compressor 22, when according to the upper drawing at the input of the compressor in the cooling medium sprayer 80 the cooling medium is sprayed under the necessary pressure, drawn from e.g. the cooling medium pipe 18 and heated in the heat exchanger 82 to the necessary temperature for the evaporation in the compressor 22.

For the heating of the cooling medium in the heat exchanger 82 the heat of the flue gas drawn from the cooled combustion chamber 1 or aggregate 51, the heat of the waste gas drawn from the heat aggregate 61, the waste heat of the steam-gas mixture from the gas turbine 28 or the heat taken off within the applied installation 30 of the Rankine-Clausius cycle can be utilized.
And/or in the design according to lower drawing between the stages of the compressor 22 in the intermediate mixing coolers 92 the cooling medium drawn from the cooling medium pipe 18 or from the pressure pipe 59 or from the injection pipe 60 is injected, by means of which the operating medium in the appropriate stage of the compressor 22 is cooled down to minimum to the dew point of the steam of the cooling medium in the operation medium of the compressor 22.

In the power cycle in the exemplary design in FIG. 10 for increasing of its efficiency an increase of the temperature of the steam-gas mixture before the input to the steam generator 31 is applied, by means of its reheating by flue gas in the steam-gas mixture reheater 83.

The reheating temperature can be controlled according to the design of the reheater 83 e.g. by means of a bypass of the reheater or its parts at the side of the steam-gas mixture, by means of a bypass at the side of the flue gas or by combination of both.

In the steam-gas power cycle in the exemplary design according to FIG. 11 for the increasing of its efficiency an increase of the temperature of the steam-gas mixture before the input to the steam generator 31 is applied by means of additional combustion of further fuel, e.g. natural gas, in the device 85′ for additive combustion.

The additive combustion is applied in such cases when higher parameters of steam are required for the installation 30 of the Rankine-Clausius cycle. For the additive combustion the air contained in the steam-gas mixture can be utilized.

In the steam-gas power cycle in the exemplary design in FIG. 12 for the cooling down of the flue gas to the required output temperature from the steam-gas generator 87 the flue-gas heater 73 of the cooling medium is applied, which can be designed for the heating of the medium to a temperature lower than the boiling temperature or also as an evaporating reheater.

The flue-gas heater 73 is applied in such cases when for the combustion of the fuel the combustion air will be sufficient of a temperature that is reached in the combustion air preheater 38 (FIG. 3) or in case if at the application of the combustion air heater 11 the necessary temperature of flue gas after the steam-gas mixture heater 7 (FIG. 3, FIG. 4) will not be reachable, in this case the combination of the flue gas heater 73 of the cooling medium and the combustion air heater 11 included after it are applicable as well.

In the connection of the power cycle in the exemplary design in FIG. 13 the waste heat of the steam-gas mixture, e.g. after the combustion air preheater 38, is utilized for the preheating of the injected medium in the exchanger 90 for the heating of the injected medium and the medium preheated in this way is by means of the pipes 26, 26b, 26c, or 26d injected into the steam-gas mixture.

By preheating of the injected medium the steam ratio in the steam-air mixture before the gas turbine 28 is increased, by including of the intermediate mixing cooler 92 it is possible to approximate the isothermal compression and especially in the exchanger 90 for the preheating of the injected medium further condensate from the steam-air mixture is acquired, which is then drained by means of the condensate pipe 49c.

In the power cycle in the exemplary design in FIG. 14 for the generation of the steam-gas mixture in the mixing piece 21 the superheated steam is used, which is acquired from the saturated steam from the output 5 of the cooling medium steam from the cooled combustion chamber 1 by means of the heating of the steam by flue gas from the cooled combustion chamber 1 in the steam superheater 106. The pressure at the steam output 5 from the cooled combustion chamber 1 corresponds to the pressure of the gas after the compressor 22.

In the power cycle in the exemplary design in FIG. 15 for the generation of the steam-gas mixture in the mixing piece 21 steam after the expansion in the high-pressure steam turbine 104 is used and the steam is of the same pressure as the gas pressure after the compressor 22.

The superheating of the steam, drawn from the output 5 of the cooled combustion chamber 1 to the required higher temperature, is performed by the flue gas from the cooled combustion chamber 1 in the steam superheater 106, the output 105 of which is connected to the high-pressure steam turbine 104. The pressure at the output 5 of the cooling medium steam from the cooled combustion chamber 1 is higher than the pressure of the steam after the compressor 22.

In the power cycle in the exemplary design in FIG. 16 for the generation of the steam-gas mixture in the mixing piece 21 only a part of the steam, which is drawn from the output 5 of the cooled combustion chamber 1, is utilized, and the remaining part of this steam is drawn by means of the supply steam pipe 108 to the steam superheater 106, in which it is superheated to the required temperature by the flue gas from the cooled combustion chamber 1 and it is by means of the output steam pipe 109 led to the steam turbine 32 of the installation 30 of the Rankine-Clausius steam cycle.

The amount of the drawn steam is controlled by flow control devices 110, the pressure at the output 5 of the cooled combustion chamber 1 corresponds to the pressure of the gas after the compressor 22.

In the power cycle in the exemplary design according to FIG. 17 for the generation of the steam-gas mixture in the mixing piece 21 only a part of the steam, which is drawn from the output 5 of the cooled combustion chamber 1, is utilized, and the remaining part of this steam is drawn by means of the supply pipe 108 to the steam superheater 106, in which it is superheated to the required temperature by the flue gas from the cooled combustion chamber 1 and it is by means of the output pipe 109 led to the condensing turbine 111 and the condensate is by means of the condensate pipe 112 led from the condenser 33 into the cooling medium tank 20. The pressure at the output 5 of the steam of the cooled combustion chamber 1 corresponds to the pressure of the gas after the compressor 22.

In the power cycle in the exemplary design in FIG. 18 for the generation of the steam-gas mixture in the mixing piece 21 only a part of the superheated steam, led by means of the main pipe 113 from the output of the back-pressure turbine 104, is utilized, and the remaining part of this steam is by means of the branching pipe 114 led to the steam turbine 32 of the installation 30 of the Rankine-Clausius steam cycle.

The amount of the extracted steam for the steam turbine 32 is controlled by the flow control devices 110 and the pressure at the output 5 of the steam of the cooled combustion chamber 1 is higher than the gas pressure after the compressor 22.

In the power cycle in the exemplary design in FIG. 19 for the generation of the steam-gas mixture in the mixing piece 21 only the part of the superheated steam from the steam superheater 106 is utilized, which is after a partial expansion in the condensing turbine 115 to a pressure corresponding to the pressure of the gas after the compressor 22 extracted by means of the extraction pipe 116 from the controlled extraction 118 and the remaining part of the steam condenses in the condenser 33 and the developed condensate is by means of condensate pipe 112 led to the cooling medium tank 20. The pressure at the output 5 of the steam from the cooled combustion chamber 1 is higher than the gas pressure after the compressor 22.

In the power cycle in the exemplary design in FIG. 20 for the generation of the steam-gas mixture in the mixing piece 21 only the part of the superheated steam from the steam superheater 106 is utilized, which is extracted from the discharge of the back-pressure turbine 119 by means of the extraction pipe 116 with a pressure corresponding to the gas pressure after the compressor 22 and the rest part of the steam is through the controlled extraction 118′ by means of the branch pipe 114 led to the steam turbine 32 of the installation 30 of the Rankine-Clausius steam cycle. The pressure at the output 5 from the cooled combustion chamber 1 is higher than the gas pressure after the compressor 22.

In the power cycle in the exemplary design in FIG. 21 the saturated steam from the output 5 of the cooled combustion chamber 1 is superheated by flue gas from the cooled combustion chamber 1 in first parts of the steam superheater 106 and it superheats to the final temperature by radiation of the flue gas and the flame in the output part 106′ of the steam superheater in the cooled combustion chamber 1.

In the alternative design the saturated steam from the output 5 of the cooled combustion chamber 1 is partly heated in the input part of the steam superheater 106 by means of flue gas after the cooled combustion chamber 1, to a higher temperature it is then heated by radiation of the flame and flue gas in the medium part 106′ of the superheater in the cooled combustion chamber 1 and then it is heated to the output temperature in the output part of the steam superheater 106 in the flue gas after the cooled combustion chamber 1.

In the power cycle in the exemplary design in FIG. 22 the saturated steam from the output 5 of the cooled combustion chamber 1 is preheated to the required temperature by means of flue gas and of the radiation of the flame in the steam superheater 106 in the cooled combustion chamber 1.

In the power cycle in the exemplary design in FIG. 23 the steam-gas mixture generated in the mixing piece 21 is heated at first by means of flue gas and the flame radiation in the input part 7′ of the steam-gas mixture heater 7 in the cooled combustion chamber 1 and to the required temperature in the outlet 9 of the steam-gas mixture the steam-gas mixture is heated by flue gas in the the steam-gas mixture heater 7 after the combustion chamber 1, e.g. in the parts 7″ and 7′″, whereas the steam-gas mixture can be cooled before the inlet to the individual parts 7′, 7″, and 7′″ of the steam-gas mixture heater 7 in the injection cooler 25, 25b and 25e.

In the power cycle in the exemplary design in FIG. 24 the steam-gas mixture generated in the mixing piece 21 is heated at first by means of flue gas after the cooled combustion chamber 1, e.g. in the parts 7′ and 7″ of the steam-gas mixture heater 7, and it is heated to the required temperature in the steam-gas mixture outlet 9 by means of flue gas and the radiation of the flame in the output part 7′″ in the cooled combustion chamber 1, whereas before the input to the single parts 7′, 7″, and 7′″ of the steam-gas mixture heater 7 the steam-gas mixture can be cooled in the injection cooler 25, 25b and 25d.

In the power cycle in the exemplary design in FIG. 25 the steam-gas mixture generated in the mixing piece 21 is heated at first by means of flue gas after the cooled combustion chamber 1 in the input part 7′ of the steam-gas mixture heater 7, further heating is performed by means of flue gas and of the radiation of the flame in the medium part 7″ of the steam-gas mixture heater 7 and the steam-gas mixture is heated to the required temperature in the steam-gas mixture outlet 9 by flue gas after the cooled combustion chamber 1 in the output part 7′″ of the steam-gas mixture heater 7, whereas before the input into the individual parts 7′, 7″, and 7′″ the steam-gas mixture can be cooled in the injection cooler 25, 25b and 25d.

1. The power cycle with the gas turbine with the indirect heating and with humid cycle, eventually combined steam-gas cycle with the same gas turbine and steam turbine, eventually with the same gas turbine with a regeneration heat exchanger, eventually with the same gas turbine with reheating before as well as after the gas turbine, eventually with the same gas turbine with isothermal compression, utilizing the primary power of fossil fuels, alternative fuels, and wastes by their combustion, eventually utilizing the sensible heat of various waste gases or mixtures of gases, characterized by the operating medium of the gas turbine (28) being the steam-gas mixture of gas supplied by compressor (22) and the steam of the cooling medium from the cooled combustion chamber (1), eventually from a cooled heat aggregate (51) or steam-gas mixture of the gas supplied by a compressor (22) and of steam of the cooling medium from the cooled combustion chamber (1), eventually from a cooled heat aggregate (51) and the steam of the injected medium into the gas supplied by the compressor (22) and/or into the steam-gas mixture or the steam-gas mixture of the gas supplied by the compressor (22) and the steam of the injected medium into the gas supplied by the compressor (22) and/or into the steam-gas mixture, whereas for the heating of the steam-gas mixture to the temperature of the operation medium of the gas turbine (28) or for the heating of the steam-gas mixture before the gas turbine (28) to a reachable temperature the heat of the leaving flue gas from the cooled combustion chamber (1) is utilized, eventually from a cooled heat aggregate (51) or the sensible heat from the aggregate (61) or the heat of flue gas and the flame in a cooled combustion chamber (1).

2. The power cycle according to claim 1 characterized by the injected medium being injected into the gas forwarded by a compressor (22) before the compressor in case of preheating of the inlet gas in the process gas heater (79), further after the compressor in case of including of the regeneration exchanger (56) and in the suction of the compressor (22) and/or between the stages of the compressor.

3. The power cycle according to claim 1 characterized by the injected medium being injected into the steam-gas mixture before the steam-gas mixture heater (7) and/or at least between some parts of the steam-gas mixture heater (7) or after the steam-gas mixture heater (7) or in a combination of the mentioned possibilities.

4. The power cycle according to claim 1 characterized by the residual heat of the leaving flue gas or waste gases after the steam-gas mixture heater (7) being utilized for the heating of the combustion air in the combustion air heater (11) and/or for the heating of the cooling medium for a cooled combustion chamber (1) or a cooled heat aggregate (51) in the flue gas heater (73) of the cooling medium or for heating of the injected medium in the heater (64) of the injected medium or in a combination of some of the mentioned possibilities.

5. The power cycle according to claim 1 characterized by the residual heat of the steam-gas mixture leaving the steam turbine (28) or the installation (30) of the steam Rankine-Clausius cycle, eventually leaving the regeneration exchanger (56) being utilized for the preheating of the combustion air.

6. The power cycle according to claim 1 characterized by the residual heat of the steam-gas mixture after the installation (30) of the steam-gas Rankine-Clausius cycle, eventually after the preheater (38) of the combustion air, being utilized for the heating of warm service water in the warm service water heater (43) or for the preheating of the additional cooling medium in the heat exchanger (77) or for the preheating of the air drawn by a compressor (22) in a heater (79) or for the heating of the injected medium in the exchanger (90) or in a combination of some of the mentioned possibilities.

7. The power cycle according to claim 1 characterized by the residual heat after the regeneration exchanger (56) being utilized for the preheating of the injection medium in the preheater (58) of the injected medium and/or for the preheating of warm service water in the heater (43) of warm service water.

8. The power cycle according to claim 1 characterized by the temperature of the steam-gas mixture after the gas turbine (28) being increased by flue gas from the cooled combustion chamber (1), eventually from the cooled heat aggregate (51), eventually by heating by the gases from an aggregate (61), in the preheater (83) of the steam-gas mixture.

9. The power cycle according to claim 1 characterized by the steam content in the steam-gas mixture in the discharge pipe (48) at the end of the gas cycle of the gas turbine (28) being reduced by including of the separation condenser (45) with a cooling medium of the temperature of the ambient or lower.

10. The power cycle according to claim 1 characterized by the separated condensate of the steam-gas mixture from the steam generator (31), eventually from the combustion air preheater (38), eventually from the heating service water heater (43), eventually from the separation condenser (45), eventually from the preheater (58) of the injected medium, eventually from the heater (79) of the drawn gas being utilized as cooling medium and/or injected medium in the steam-gas power cycle.

11. The power cycle according to claim 1 characterized by the utilization of the cooling medium steam from the output (5) of the cooled combustion chamber (1) of a pressure corresponding to the pressure of the gas after the compressor (22) after its superheating to a higher temperature in the steam superheater (106) for the generation of the steam-gas mixture in the mixing piece (21).

12. The power cycle according to claim 1 characterized by the utilization only of a part of the steam from the output (5) of the cooled combustion chamber (1) with the pressure corresponding to the pressure of the gas after the compressor (22) for the generation of the steam-gas mixture in the mixing piece (21) and the remaining part of this steam is after its superheating to a higher temperature in the steam superheater (116) utilized in the steam turbine (32) of the installation (30) of the Rankine-Clausius cycle, eventually it is utilized in a condensing steam turbine (111).

13. The power cycle according to claim 1 characterized by the utilization of the cooling medium steam from the output (5) of the cooled combustion chamber (1) with a higher pressure than the pressure after the compressor (22) after its superheating to a higher temperature in the steam superheater (106) and after the expansion in the back-pressure steam turbine (104) to a pressure corresponding to the pressure of the gas after the compressor (22) for the generation of the steam-gas mixture in the mixing piece (21), eventually only a part of this steam is utilized and its remaining part is used in the steam turbine (32) of the installation (30) of then Rankine-Clausius cycle, eventually only a part of the steam of the superheater (106) after its expansion in a condensing turbine (115) to the pressure in the controlled extraction (118) corresponding to the pressure of the gas after the compressor (22) and the remaining part of this steam condenses in the condenser (33) of this turbine, eventually only a part of the steam from the steam superheater (116) is utilized after its expansion in the back-pressure turbine (119) to a pressure corresponding to the pressure of the gas after the compressor (22) and the remaining part of this steam is after the expansion to the pressure in the controlled extraction (118′) utilized in the steam turbine (32) of the installation (30) of the Rankine-Clausius steam cycle.

14. The superheater (106) of the steam of the cooling medium according to claim 11 characterized by its design of one or more parts, whereas one part is placed in the cooled combustion chamber (1).

15. The heater of the steam-gas mixture (7) according to claim 1 characterized by being designed of more parts, of which the input part (7′) or some of the inner parts (7″) or the output part (7′″) is placed in the cooled combustion chamber (1), whereas other parts are placed in the flue gas after the cooled combustion chamber (1).

16. The power cycle according to claim 2 characterized by the residual heat of the leaving flue gas or waste gases after the steam-gas mixture heater (7) being utilized for the heating of the combustion air in the combustion air heater (11) and/or for the heating of the cooling medium for a cooled combustion chamber (1) or a cooled heat aggregate (51) in the flue gas heater (73) of the cooling medium or for heating of the injected medium in the heater (64) of the injected medium or in a combination of some of the mentioned possibilities.

17. The power cycle according to claim 3 characterized by the residual heat of the leaving flue gas or waste gases after the steam-gas mixture heater (7) being utilized for the heating of the combustion air in the combustion air heater (11) and/or for the heating of the cooling medium for a cooled combustion chamber (1) or a cooled heat aggregate (51) in the flue gas heater (73) of the cooling medium or for heating of the injected medium in the heater (64) of the injected medium or in a combination of some of the mentioned possibilities.

18. The power cycle according to claim 2 characterized by the residual heat of the steam-gas mixture leaving the steam turbine (28) or the installation (30) of the steam Rankine-Clausius cycle, eventually leaving the regeneration exchanger (56) being utilized for the preheating of the combustion air.

19. The power cycle according to claim 3 characterized by the residual heat of the steam-gas mixture leaving the steam turbine (28) or the installation (30) of the steam Rankine-Clausius cycle, eventually leaving the regeneration exchanger (56) being utilized for the preheating of the combustion air.

20. The power cycle according to claim 4 characterized by the residual heat of the steam-gas mixture leaving the steam turbine (28) or the installation (30) of the steam Rankine-Clausius cycle, eventually leaving the regeneration exchanger (56) being utilized for the preheating of the combustion air.
